(19) United States
(12) Patent Application Publication
(10) Pub. No.: US 2026/0196106 A1
(43) Pub. Date: Jul. 9, 2026

(54) UNLOCKABLE MULTIPLE LEVEL PRIZE DISKS

(71) Applicant: IGT, Las Vegas, NV (US)

(72) Inventor: Jennifer BAUTISTA, Albany, CA (US)

(73) Assignee: IGT, Las Vegas, NV (US)

(21) Appl. No.: 19/554,078

(22) Filed: Mar. 2, 2026

Related U.S. Application Data
(63) Continuation of application No. 17/576,563, filed on Jan. 14, 2022, now abandoned.

(51) Int. Cl. G07F 17/32

(52) U.S. Cl. CPC G07F 17/3267; G07F 17/3213

(57) ABSTRACT

An electronic gaming machine (EGM) is provided. The EGM includes a processor circuit and a memory device which stores a plurality of instructions, which when executed by the processor circuit, cause the processor circuit to perform operations. Operations include displaying, by a display device of a gaming device, a graphical interface for a wagering game including multiple reels, multiple prize disks and an unlock symbol that includes a first unlock symbol that corresponds to an unlock function of one of the prize disks. Operations include determining that the unlock symbol comprises the first unlock symbol that causes one of the prize disks to become unlocked, determining that one of the primary game symbols includes a secondary game symbol that corresponds to user access to the secondary game, and awarding the user with a bonus game award based on a combination of corresponding bonus game symbols.

### CROSS REFERENCE TO RELATED APPLICATIONS

The present application is a continuation of U.S. Patent Application No. 17/576,563, filed January 14, 2022, entitled, “UNLOCKABLE MULTIPLE LEVEL PRIZE DISKS,” the disclosure and content of which is incorporated herein in its entirety.

### BACKGROUND

Gaming machines may provide players awards in primary games. Gaming machines generally require the player to place a wager to activate the primary game. The award may be based on the player obtaining a winning symbol or symbol combination and on the amount of the wager. Increasing player anticipation regarding different avenues for winning may increase excitement.

### BRIEF SUMMARY

In some embodiments, the present disclosure is related to operations that may be performed by an electronic gaming machine (EGM) that includes a processor circuit and a memory device which stores a plurality of instructions, which when executed by the processor circuit, cause the processor circuit to perform operations herein. Operations include displaying a graphical interface for a wagering game by a display device of a gaming device in response to receiving a wager from a user of the gaming device. The graphical interface may display multiple reels each including multiple primary game symbols corresponding to a primary game on the gaming device and configured to move in a first direction. The graphical interface may display multiple prize disks that each include multiple bonus game symbols corresponding to a secondary game on the gaming device and configured to move in a second direction that is different from the first direction. The graphical interface may display an unlock symbol that includes a first unlock symbol that corresponds to an unlock function of one of the prize disks or a second unlock symbol that corresponds to a lock function of one of the prize disks.

Operations include determining that the unlock symbol includes the first unlock symbol that causes one of the prize disks to become unlocked and determining that one of the primary game symbols includes a secondary game symbol that corresponds to user access to the secondary game.

Based on one of the prize disks becoming unlocked and one of the primary game symbols including the secondary game symbol, operations include awarding the user with a bonus game award including a combination of corresponding ones of the bonus game symbols.

Some embodiments are directed to a gaming system that includes a processor circuit and a memory device which stores multiple of instructions, which when executed by the processor circuit cause the processor circuit to display, in response to receiving a wager from a user of a gaming device, a graphical interface for a wagering game comprising multiple reels each including multiple primary game symbols corresponding to a primary game on the gaming device and configured to rotate about a first axis. The graphical interface further displays multiple prize disks each including multiple of bonus game symbols corresponding to a secondary game on the gaming device and configured to rotate about a second axis that is orthogonal to the first axis. The graphical interface further displays an unlock symbol that corresponds to an unlock function of one of the prize disks. Operations include determining that the unlock symbol corresponds to one of the prize disks, determining that one of the primary game symbols includes a secondary game symbol that corresponds to user access to the secondary game and, based on the one of the prize disks becoming unlocked and the one of the primary game symbols including the secondary game symbol, awarding the user with a bonus game award.

In some embodiments, the bonus game award includes a product of a money value in a first prize disk of the prize disks and a multiplier in a second prize disk of the prize disks.

Some embodiments herein are directed to methods of operating a gaming system including operations of displaying, by a display device of a gaming device in response to receiving a wager from a user of the gaming device, a graphical interface for a wagering game. The graphical interface is operable to display multiple reels each including primary game symbols corresponding to a primary game on the gaming device and configured to rotate about a first axis and multiple prize disks each including multiple bonus game symbols corresponding to a secondary game on the gaming device and configured to rotate about a second axis that is orthogonal to the first axis. The graphical interface further displays an unlock symbol that corresponds to an unlock function of one of the prize disks. Operations include determining that the unlock symbol corresponds to one of the prize disks, determining that one of the primary game symbols includes a secondary game symbol that corresponds to user access to the secondary game and, based on the one of the prize disks becoming unlocked and the one of the primary game symbols including the secondary game symbol, awarding the user with a bonus game award. In some embodiments, the prize disks include a first prize disk and a second prize disk, wherein the first prize disk is between the reels and the second prize disk, and wherein the first prize disk is configured to move in a first direction of left and right directions and the second prize disk is configured to move in a second direction of the left and right directions that is different from the first direction.

Additional features are described herein and will be apparent from the following Detailed Description and the figures.

### BRIEF DESCRIPTION OF THE DRAWINGS

FIG. 1 is a schematic block diagram that illustrates a display of a multi-level prize disk according to some embodiments.

FIGS. 2A and 2B are schematic block diagrams that illustrate a display of a multi-level prize disk according to some embodiments.

FIG. 3 is a schematic block diagram that illustrates a display of a multi-level prize disk according to some embodiments.

FIG. 4 is a schematic block diagram that illustrates a display of a multi-level prize disk according to some embodiments.

FIG. 5 is a schematic block diagram that illustrates a display of a multi-level prize disk according to some embodiments.

FIGS. 6A-6F are schematic block diagrams that illustrate a display of a multi-level prize disk according to some embodiments.

FIG. 7 is a schematic block diagram that illustrates a display of a multi-level prize disk according to some embodiments.

FIG. 8 is a schematic block diagram that illustrates a display of a multi-level prize disk according to some embodiments.

FIG. 9 is a flow chart of some embodiments of processes for operating a gaming system which provides multiple unlockable prize disks according to some embodiments.

FIG. 10 is a schematic block diagram some embodiments of an electronic configuration of an example gaming system disclosed herein.

FIGS. 11A and 11B are perspective views of some embodiments of the gaming system disclosed herein.

FIG. 11C is a front view of some embodiments of a personal gaming device of the gaming system disclosed herein.

### DETAILED DESCRIPTION

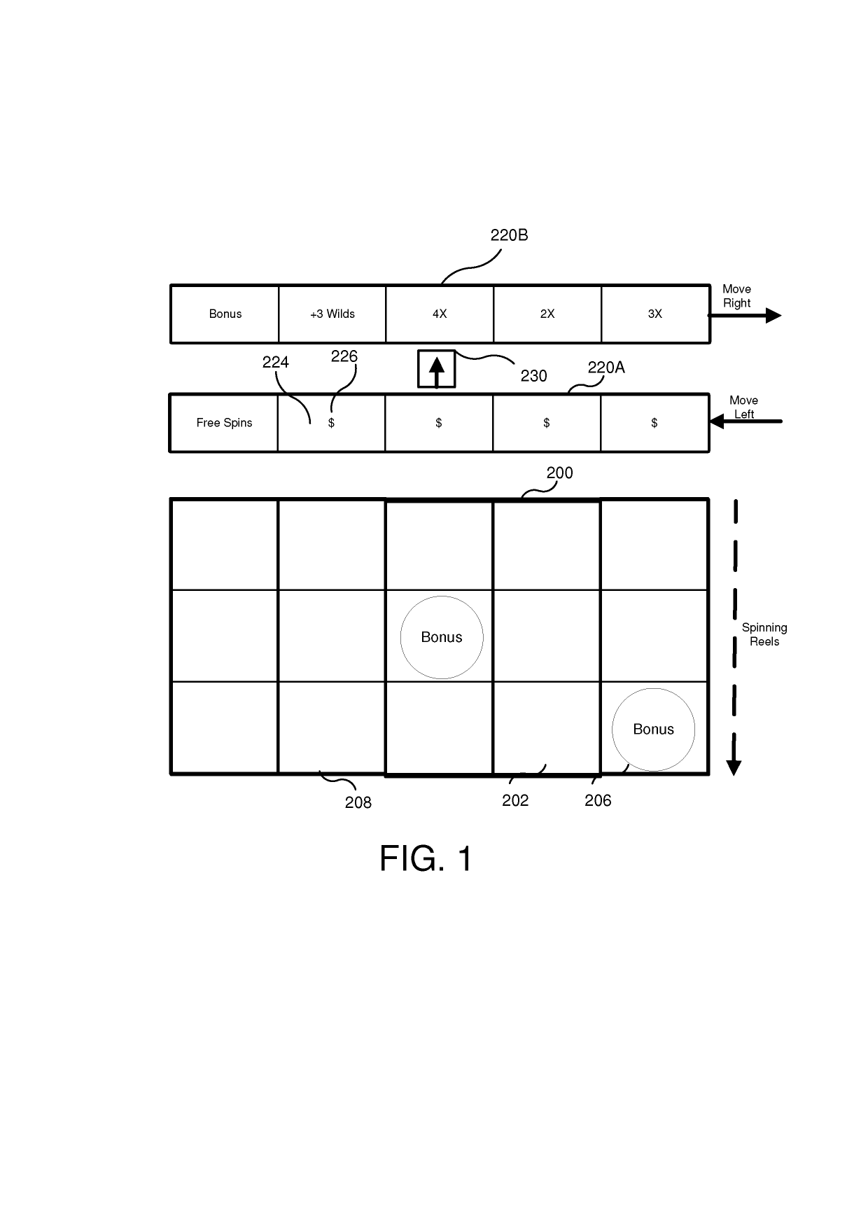

In various embodiments, the present disclosure relates generally to systems and methods that include multi-level prize disks in combination with multiple reels. For example, brief reference is now made to FIG. 1, which is a schematic block diagram that illustrates a display of a multi-level prize disk according to some embodiments. As illustrated a bank of reels 200 includes multiple reels 202 that are operable to spin during game play and stop to determine any matches of symbols in the display positions of the reels 200. In some embodiments, the reels 220 may spin about a reel axis that is substantially horizontal and may spin to cause the symbols in the display positions to appear to spin in a down direction in the front displayed portions of the reels 200.

A multi-level prize disk 220 may include a first prize disk 220A that is adjacent the bank of reels 200 and that includes multiple disk display positions 224 comprising bonus game symbols 226. The first prize disk 220A may spin horizontally about a disk axis that is substantially vertical. In some embodiments, the reel axis and the disk axis may be orthogonal. In some embodiments, the prize disks 220 may spin in opposite directions relative to one another. For example, the first prize disk 220A may appear to spin with the front facing disk display positions 224 moving the left. Similarly, some embodiments provide that the second prize disk 220B may appear to spin with the front facing disk display positions 224 moving to the right.

The multi-level prize disk 220 may include a second prize disk 220B that is adjacent the first prize disk 220A. For example, some embodiments provide that the first prize disk 220A is between the reels 202 and the second prize disk 220B. Each of the first and second prize disks 220 may include disk display positions 224 that may each correspond to one of the reels 202.

An unlock symbol 230 may be between the first and second prize disks 220A, 220B and/or may be between the one of the prize disks 220 and the bank of reels 200. In some embodiments, responsive to the unlock symbol 230 indicating to unlock one or more of the prize disks 220, may cause a bonus game award to be generated based on reels 202 that include a bonus symbol 206 in ones of the reel display positions 208. Although these embodiments are illustrated with just two prize disks 220, other embodiments may include more than two prize disks 220 that may collectively interact to determine one or more bonus game awards.

Some embodiments provide that the unlockable prize disks 220 may unlock on a single spin of the primary game on the EGM. In some embodiments, an unlock operation may apply to a single spin and may not carryover to subsequent spins. For example, the game may begin with the first prize disk 220A being always active and the second prize disk 220B being visible but not active. In some embodiments, the first and second prize disks 220 may move in opposite directions every spin. In some embodiments, the first and second prize disks 220 may only move one position for each spin. In the illustrated embodiments, the unlock symbol 230 is above the middle reel 202.

On each spin, the first and second prize disks 220A, 220B may each move one position in opposite directions from one another. On every spin, the unlock symbol 230 may be displayed as a first unlock symbol that corresponds to an unlock function of one of the prize disks 220 or a second unlock symbol that corresponds to a lock function of one of the prize disks 220. In some embodiments, the unlock symbol may include an unlock reel that includes multiple positions that correspond to locking and/or unlocking the prize disks 220. In some embodiments, the unlock symbol 230 shows an actual symbol for an unlock symbol and nothing for a lock symbol.

If the first unlock symbol 230 is an arrow that displayed after a spin, then any reel with the designated bonus game symbol 206 may cause a bonus game award to be generated based on the values of the corresponding positions on the prize disks 220. For example, based on the presence of the unlock symbol 230, the second prize disk 220B is unlocked. Further, based on the presence of the bonus game symbol 206 in the third and fifth reels 202, the player may be awarded a bonus game award based on the first and second prize disks 220 in the third and fifth reel locations. For example, the user would win 4X the amount of money listed in the third position of the first prize disk 220A and 3X the amount of money in the fifth position of the first prize disk 220A.

Some embodiments provide that at the beginning of the next spin, the second prize disk 220B may reset to being locked for that spin. In this manner, some embodiments provide that the unlock status is not persistent. In some embodiments, the second (top) prize disk 220B may contain wealthier features than those offered by the first (bottom) prize disk 220A.

In some embodiments, the unlock operation corresponds to all of the unlocked prize disks 220 being available for the bonus game award while in other embodiments, the unlock symbol may only apply to the column/reel that corresponds to the location of the unlock symbol.

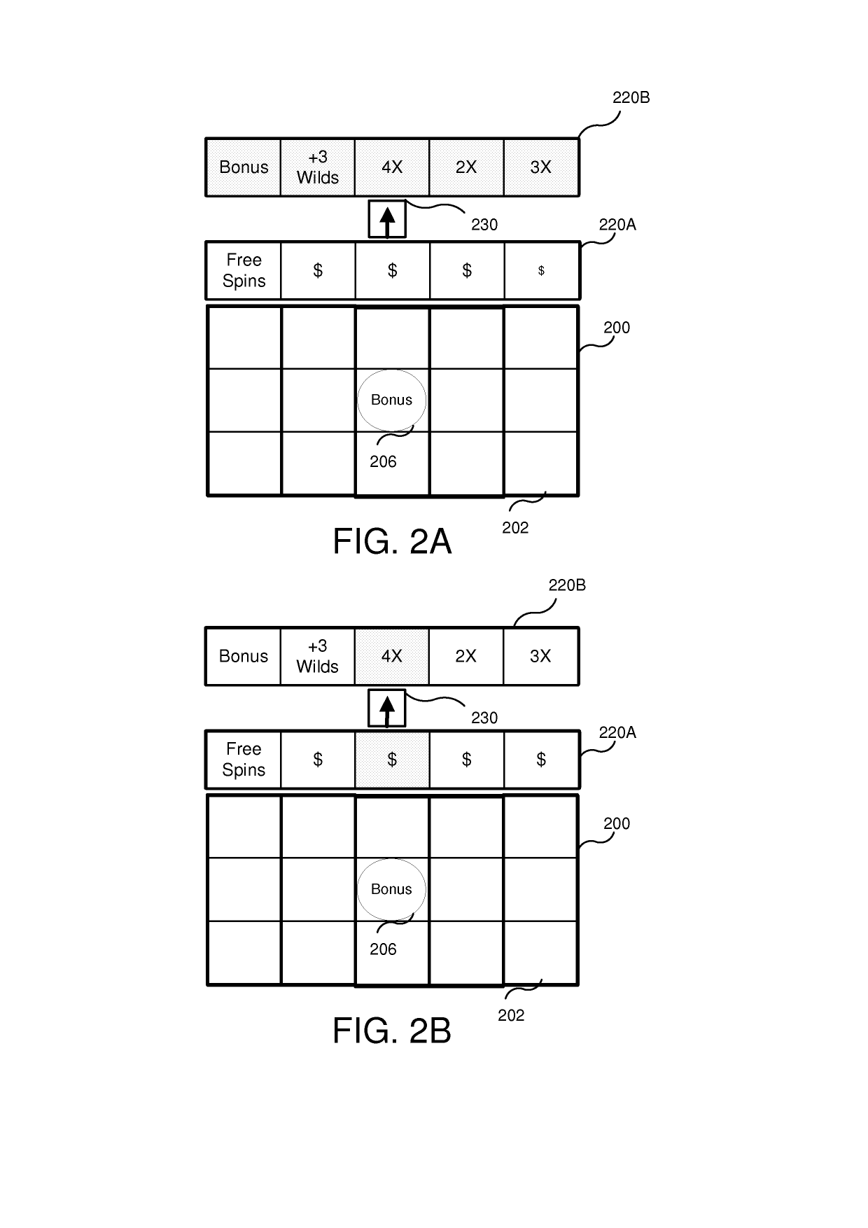

Brief reference is made to FIGS. 2A and 2B, which are schematic block diagrams that illustrates a display of a multi-level prize disk according to some embodiments. Referring to FIG. 2A, a first spin causes the reels to spin and the prize disks 220 to move one position. The unlock symbol 230 causes the second prize disk 220B to become unlocked. Referring to FIG. 2B, based on the bonus game symbol 206 being in the third reel 202, the user is awarded a bonus prize that corresponds to the values in the corresponding display portions of the first and second prize disks 220. For example, in the illustrated embodiment, the user would be awarded 4X the amount of money listed above the third reel in the first prize disk 220A.

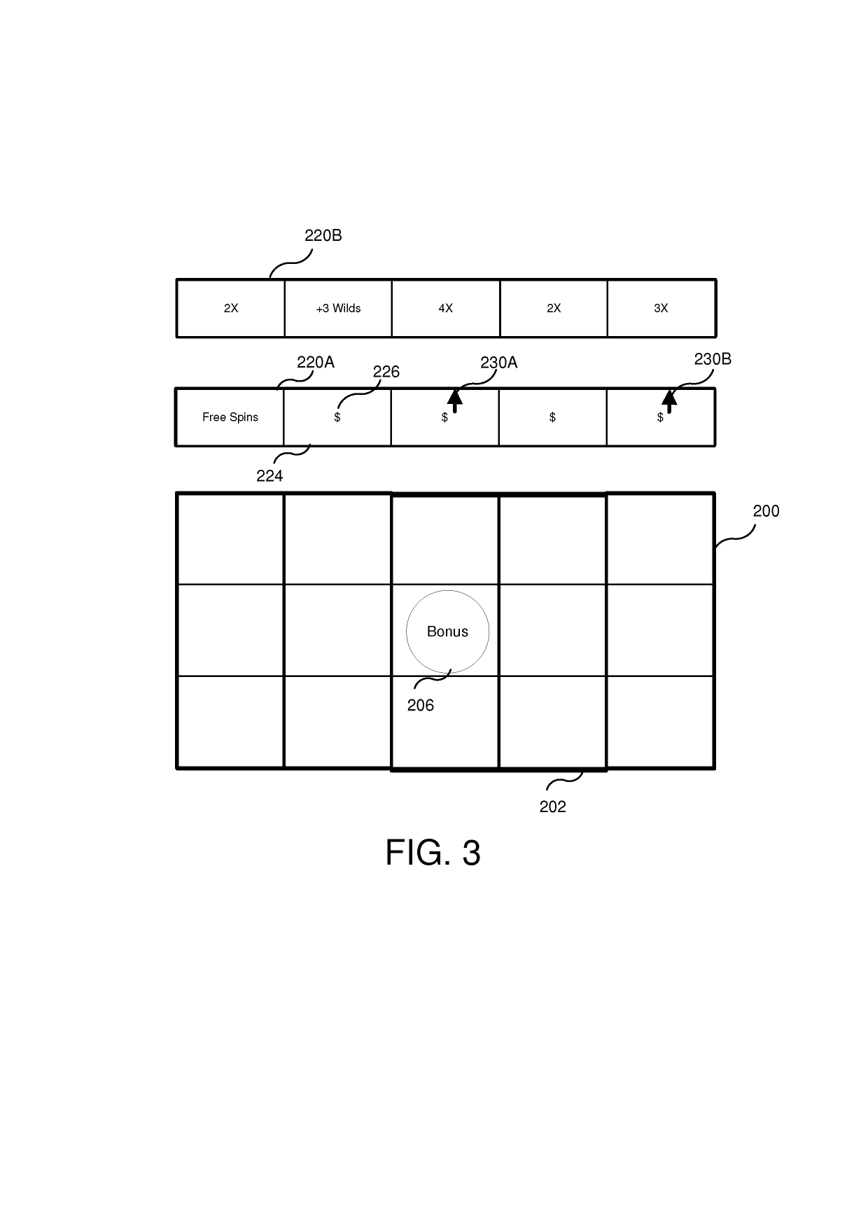

In some embodiments of unlockable prize disks, a disk may be unlocked at multiple points on a single spin without unlocking all of the display portions of a given prize disk. For example, brief reference is now made to FIG. 3, which is a schematic block diagram that illustrates a display of a multi-level prize disk according to some embodiments. The display of FIG. 3 is similar to that of FIG. 1 with the primary difference being the column-specific unlock symbols 230A and 230B. As illustrated, individual display portions of the second prize disk 220B may be unlocked without unlocking other ones of the display portions on the same prize disk. In this example, the user would be awarded 4X the amount in the corresponding display portion of the first prize disk 220A.

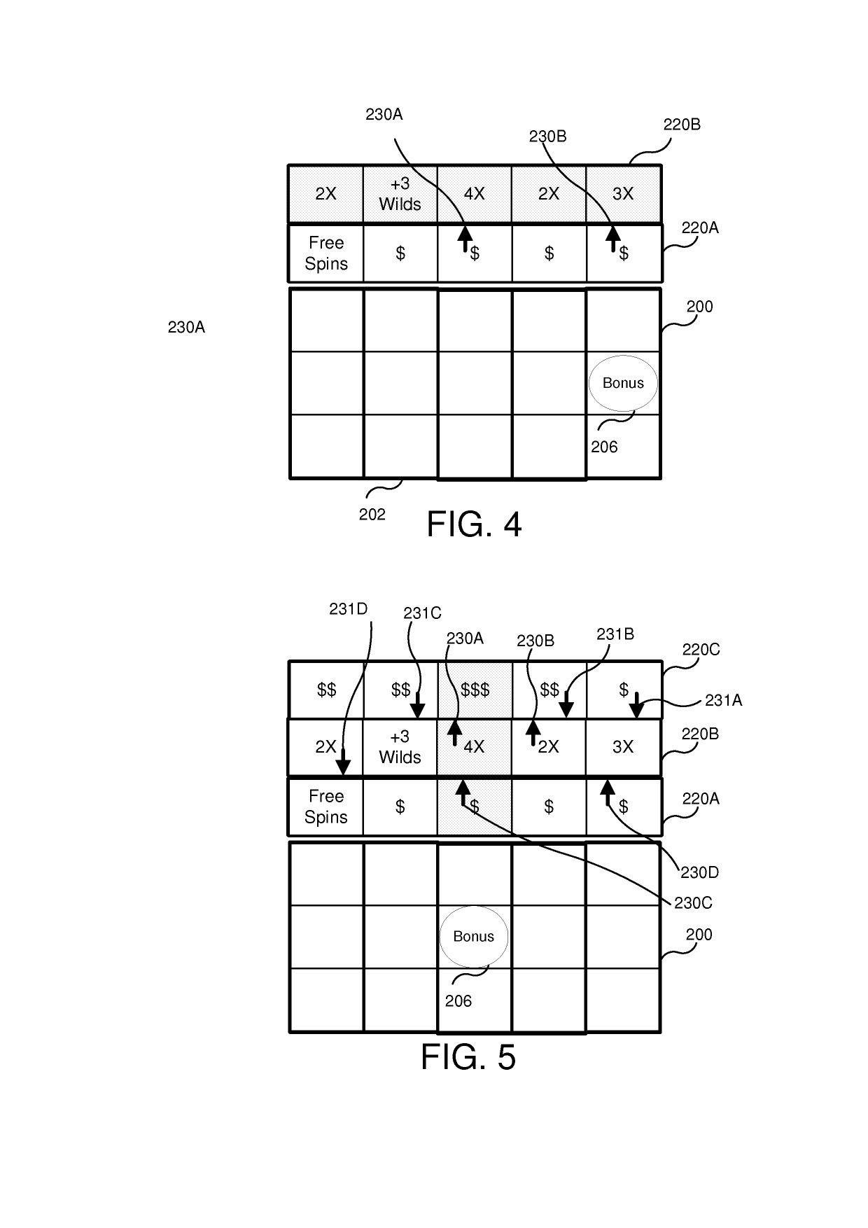

Reference is now made to FIG. 4, which is a schematic block diagram that illustrates a display of a multi-level prize disk according to some embodiments. As illustrated, a first spin causes the reels to spin and the prize disks 220 to move one position. Column-specific unlock symbols 230A, 230b cause two different display portions of the second prize disk 220B to become unlocked. Based on the bonus game symbol 206 being in the fifth reel 202, the user is awarded a bonus prize that corresponds to the values in the corresponding display portions of the first and second prize disks 220. For example, in the illustrated embodiment, the user would be awarded 3X the amount of money listed above the fifth reel 202 in the first prize disk 220A.

Reference is now made to FIG. 5, which is a schematic block diagram that illustrates a display of a multi-level prize disk according to some embodiments. Some embodiments include unlockable prize disks that include a persistent unlock. Embodiments herein may include more than two prize disks. As illustrated, bottom, middle and top prize disks 220A, 220B, 220C may be used. Some embodiments start with one of the prize disks 220 being active and the other prize disks being inactive but visible. Some embodiments provide that the middle prize disk 220B may spin an opposite direction from the first and third prize disks 220A, 220C on every spin.

In some embodiments, multiple unlock symbols are provided that provide selective locking/unlocking of portions of each prize disk 220. For example, first unlocking symbols 230A-D may correspond to an unlock function while second unlocking symbols 231A-D may correspond to a locking function. Some embodiments provide that the unlock/lock state does not reset on the next spin. When the bonus symbol triggers the prize disk and the corresponding prize disk symbol contains an unlock arrow symbol, then the prize disk above is unlocked and all prizes on unlocked prize disks 220 are awarded on that spin. In some embodiments, the additional prize disks 220 remain unlocked across spins until the prize disk feature is awarded and the lock symbol is indicated on an active prize disk 220.

Some embodiments provide that a game may start with one of the prize disks (e.g., 220A) being always active and the other prize disks 220B, 220C being inactive but visible. In some embodiments, the middle prize disk 220B may move in an opposite direction from that of the top and bottom prize disks 220C, 220A. Some embodiments provide that the unlock symbols, both lock and unlock, may be on the prize disks 220.

Some embodiments provide that an unlock state and a lock state may not reset on a subsequent spin. Some embodiments provide that when a bonus symbol 206 triggers a prize disk 220 and a corresponding prize disk symbol includes an unlock symbol having an unlock state, the prize disk 220 above is unlocked and all the prizes on the unlocked prize disks 220 are awarded on that spin.

Additional prize disks (e.g., 220C) may remain unlocked across spins until the prize disk feature is awarded and the unlock symbol is changed to a locked state.

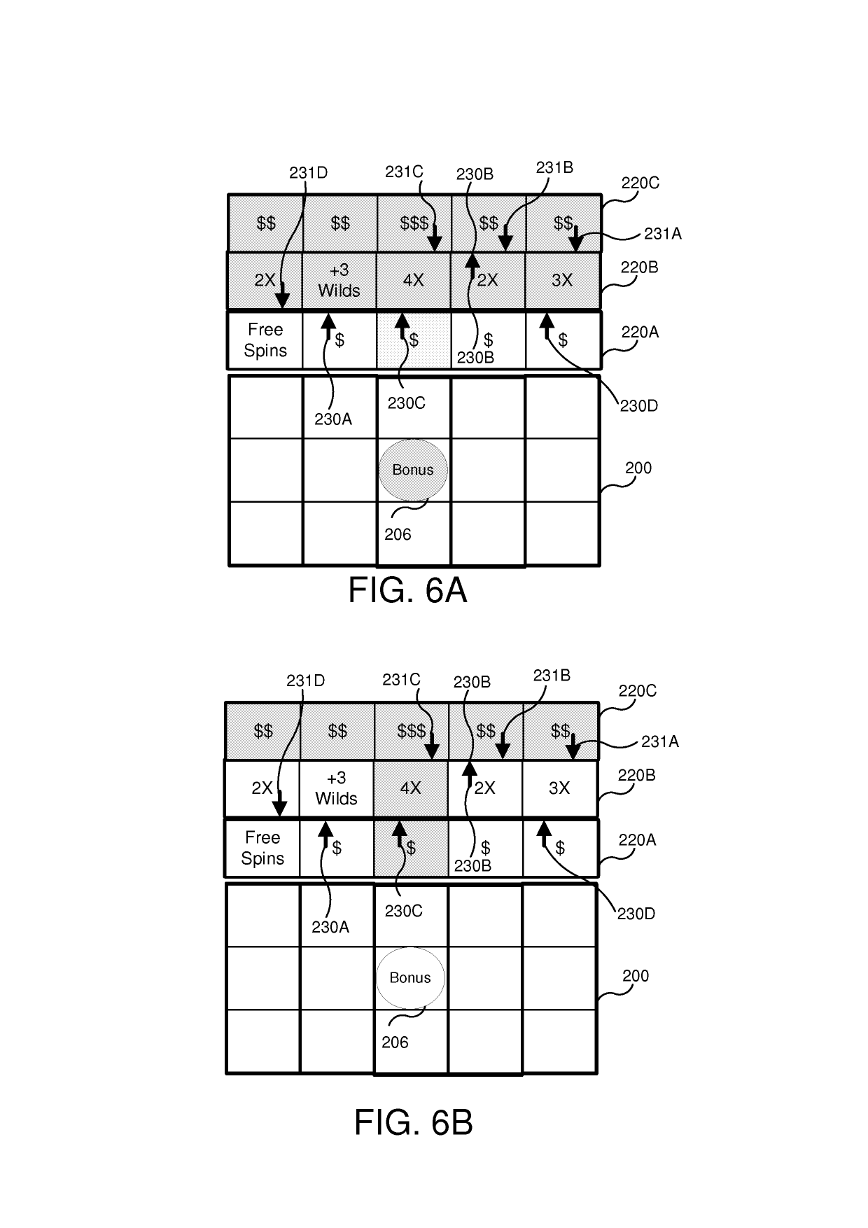

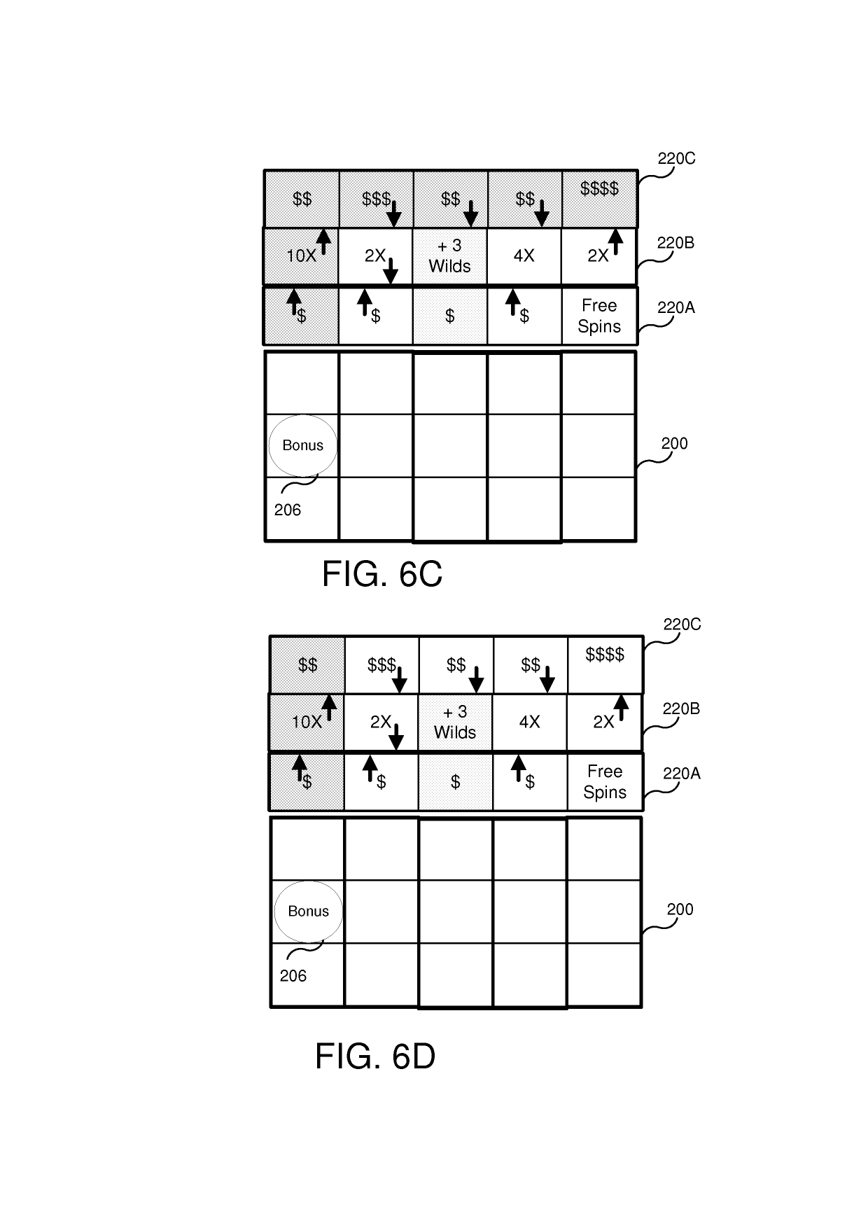

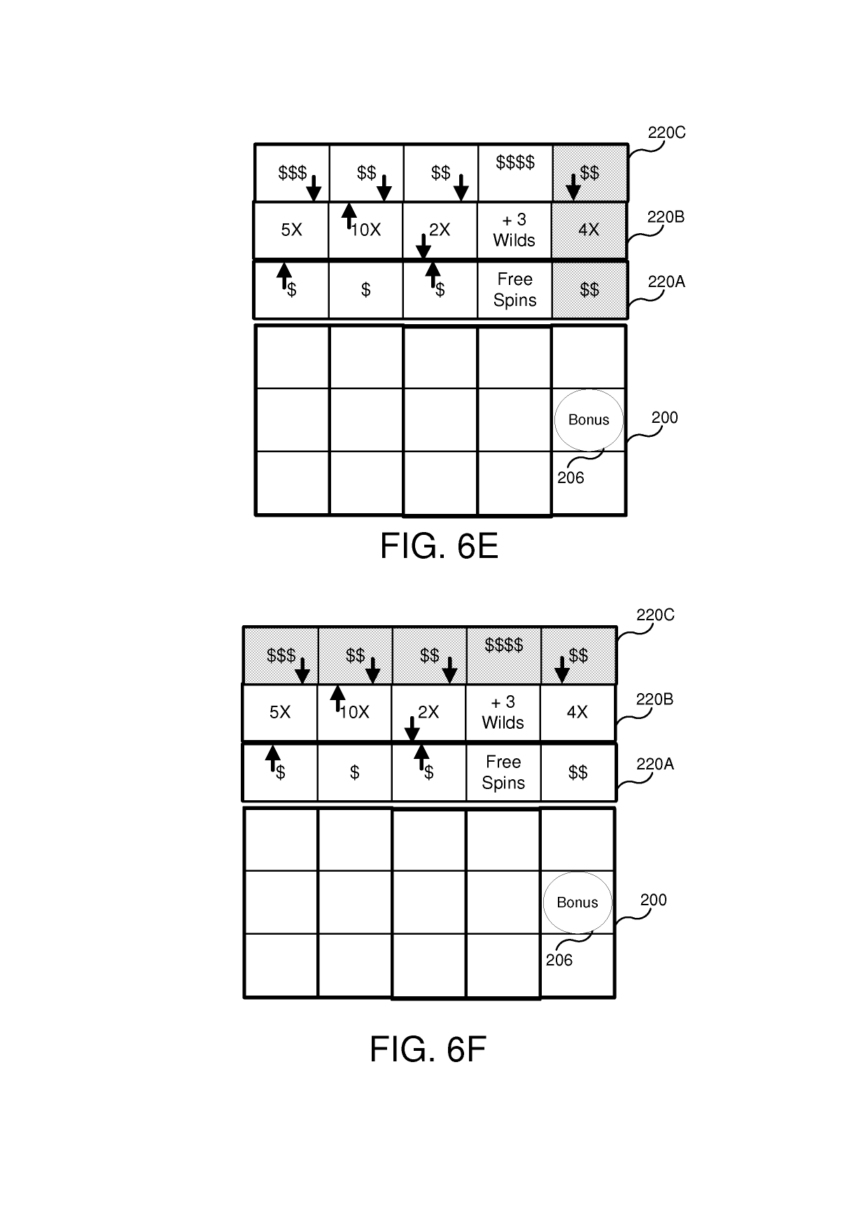

Reference is now made to FIGS. 6A-6F, which are schematic block diagrams that illustrates a display of a multi-level prize disk according to some embodiments. Referring to FIG. 6A, a first spin is resolved to pay the amount in the corresponding column based on the bonus symbol 206. The amount may be the amount in the corresponding column of the first prize disk 220A. Additionally, since the first prize disk 220A includes an unlock symbol 230C in the third column, the corresponding portion of the second prize disk 220B is unlocked. Referring to FIG. 6B, the award amount may be the amount in the third column of the first prize disk 220A times the value in the third column of the second prize disk 220B. For example, the award amount may be 4 times the amount $. In some embodiments, the second prize disk 220B may now remain active for the next spin.

Referring to FIG. 6C, a second spin may result in resolving a win corresponding to the bonus symbol 206 in the first column. Since the first and second prize disks 220A, 220B are unlocked, then the award amount corresponds to the $ in the first prize disk 220A and the 10X in the second prize disk 220B. Further, as provided in FIG. 6D, the third prize disk 220C is unlocked.

Referring to FIG. 6E, a third spin may result in resolving a win corresponding to the bonus symbol 206 in the fifth column. Since the first, second and third prize disks 220 are unlocked, the award amount may be 4X times the amount in the third prize disk 220C and the amount in the first prize disk 220A. In some embodiments, the appearance of the unlock symbol at the column including the bonus symbol 206 may result in the lock arrow in the third prize disk causing the third prize disk 220C to become locked after the award is provided.

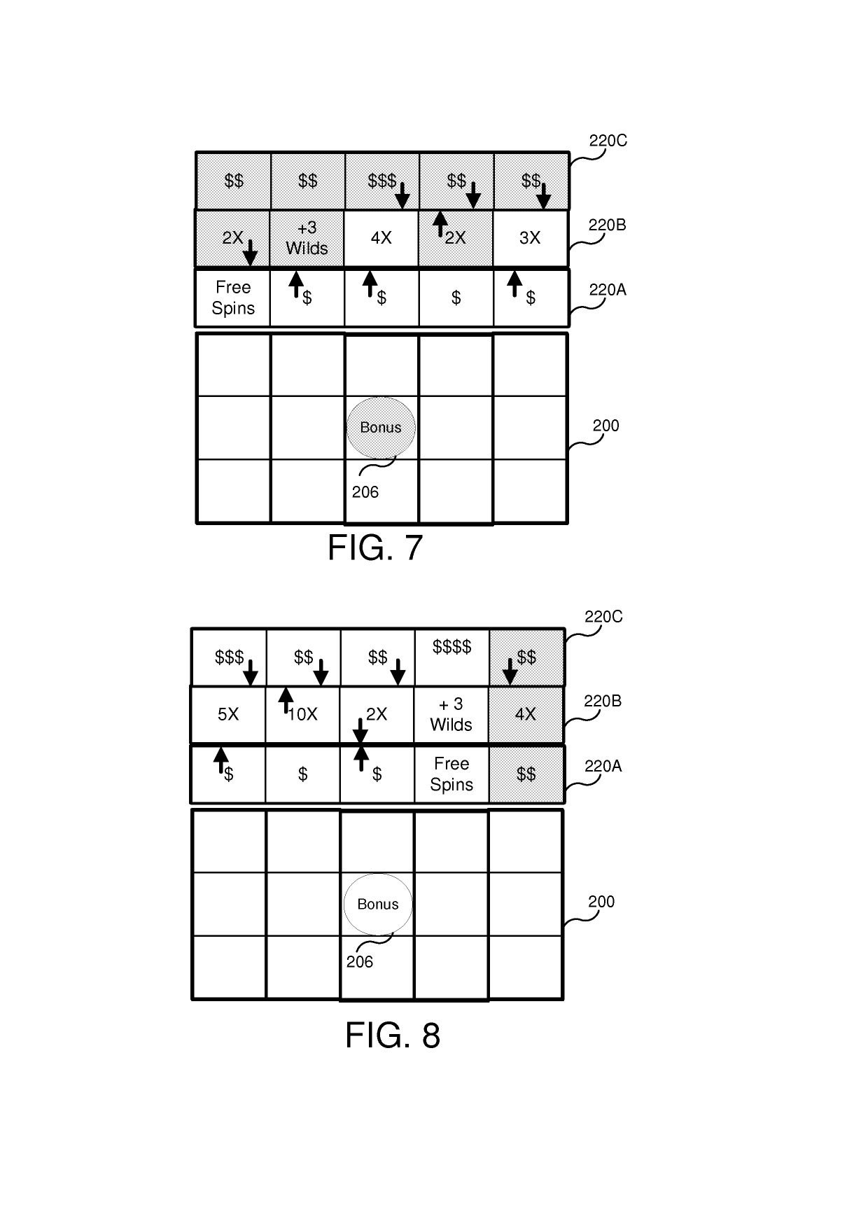

Brief reference is now made to FIG. 7, which is a schematic block diagram that illustrates a display of a multi-level prize disk according to some embodiments. In some embodiments, when the bonus symbol 206 triggers the prize disk 220 and the corresponding prize disk symbol contains an unlock symbol, then the prize disk position above the unlock symbol is unlocked and not the entire prize disk 220 and both prizes awarded on that spin. Some embodiments provide that this position may remain active for the next spin. In some embodiments, that prize may be unlocked for the next spin. As such, with the 4x on the middle disk, the prizes on the disk would shift one position on the next spin so that it would only be available on the 4^{th} position in the middle disk (if the middle disk prizes all move to the right) and that middle position would be locked. Once that prize moves off the visible screen, it is no longer available/active.

Brief reference is now made to FIG. 8, which is a schematic block diagram that illustrates a display of a multi-level prize disk according to some embodiments. Some embodiments provide that in the case of an up arrow corresponding to an unlock function and a down arrow corresponding to a lock function indicating on the same spin, both may be awarded and both may be maintained as unlocked. In some embodiments, all arrows below the top most arrow may be treated as inactive.

In the case in which a down arrow corresponding to a lock function is on a middle prize disk 220B and the top prize disk 220C is unlocked, then the arrow may be treated as inactive and/or the middle prize disk 220B may be locked and the top prize disk 220C may be kept unlocked.

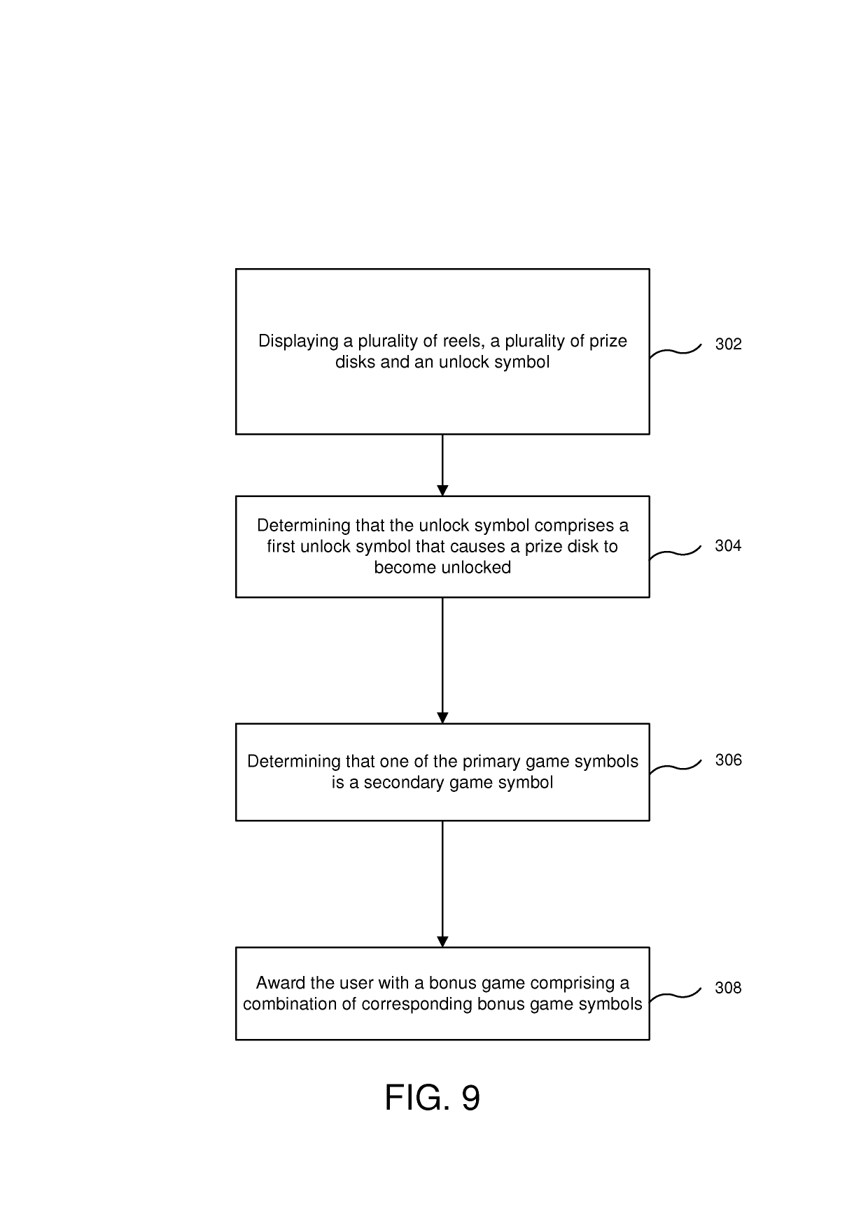

Reference is now made to FIG. 9, is a flow chart of some embodiments of processes for operating a gaming system that provides multiple unlockable prize disks according to some embodiments. Some embodiments provide that operations described herein may be performed by an electronic gaming machine (EGM) that includes a processor circuit and a memory device which stores a plurality of instructions, which when executed by the processor circuit, cause the processor circuit to perform operations herein. Operations include displaying (block 302) a graphical interface for a wagering game by a display device of a gaming device in response to receiving a wager from a user of the gaming device. The graphical interface may display multiple reels each including multiple primary game symbols corresponding to a primary game on the gaming device and configured to move in a first direction. The graphical interface may display multiple prize disks that each include multiple bonus game symbols corresponding to a secondary game on the gaming device and configured to move in a second direction that is different from the first direction. The graphical interface may display an unlock symbol that includes a first unlock symbol that corresponds to an unlock function of one of the prize disks or a second unlock symbol that corresponds to a lock function of one of the prize disks.

Operations include determining (block 304) that the unlock symbol includes the first unlock symbol that causes one of the prize disks to become unlocked and determining (block 306) that one of the primary game symbols includes a secondary game symbol that corresponds to user access to the secondary game.

Based on one of the prize disks becoming unlocked and one of the primary game symbols including the secondary game symbol, operations include awarding (block 308) the user with a bonus game award including a combination of corresponding ones of the bonus game symbols.

In some embodiments, the first direction corresponding to the reels is up or down and the second direction corresponding to the prize disks is horizontal to a left direction or horizontal to a right direction.

In some embodiments, the prize disks include a first prize disk and a second prize disk, the first prize disk is between the reels and the second prize disk, and the first prize disk is configured to move in a first direction of left and right directions and the second prize disk is configured to move in a second direction of the left and right directions that is different from the first direction.

In some embodiments, corresponding ones of the bonus game symbols in the prize disks are in a same column as the secondary game symbol in one of the reels.

Some embodiments provide that, responsive to the unlock symbol including the first unlock symbol, all of one of the prize disks is unlocked.

In some embodiments, responsive to the unlock symbol including the first unlock symbol, only a single column in one of the prize disks is unlocked.

In some embodiments, the prize disks include a first prize disk, a second prize disk and a third prize disk and the first prize disk includes a first side that is adjacent the reels and a second side that is opposite the first side. Some embodiments provide that the second prize disk includes a third side that is adjacent the second side of the first prize disk and a fourth side that is opposite the third side of the second prize disk and the third prize disk includes a fifth side that is adjacent the fourth side of the second prize disk. In some embodiments, a game starts with the first prize disk active, the second prize disk includes the unlock symbol, the third prize disk is unlockable based on the unlock symbol of the second prize disk, the secondary game symbol triggers the bonus game award, and the third prize disk resets to locked at a beginning of a next play of the game.

Some embodiments provide that the unlock symbol includes multiple unlock symbols that include a first unlock symbol and a second unlock symbol. In some embodiments, responsive to the first prize disk including the first unlock symbol, the second prize disk is unlocked, and, responsive to the second prize disk including the second unlock symbol, the third prize disk in unlocked.

In some embodiments, the prize disks comprise a first prize disk and a second prize disk, and, responsive to the first unlock symbol being on the first prize disk, the second prize disk is unlocked without unlocking the first prize disk.

In some embodiments, the prize disks include a first prize disk and a second prize disk, and, in response to the second unlock symbol being on the first prize disk, the second prize disk is locked.

In some embodiments, the unlock symbol is persistent to be active for multiple plays of the primary game.

Some embodiments provide that the unlock symbol includes multiple unlock symbols and that ones of the unlock symbols are in cells of a top row in the reels with ones of the primary game symbols.

In some embodiments, responsive to displaying the unlock symbol on a first game play, one of the prize disks is unlocked for a second game play that occurs after the first game play.

In some embodiments, the prize disks include a first prize disk and a second prize disk, the first prize disk includes money values and second prize disk includes a multiplier, and the bonus game award includes a product of the money value and multiplier in a column corresponding to the secondary game symbol.

In some embodiments, the prize disks include a first prize disk and a second prize disk Some embodiments provide that a game starts with the first prize disk active and including the unlock symbol, the second prize disk is unlockable based on unlock symbol value in first prize disk, the secondary game symbol in one of the reels triggers the bonus game award, and the second prize disk resets to locked at a beginning of next game play.

In some embodiments, the prize disks include a first prize disk and a second prize disk, the first prize disk is unlocked and the second prize disk is locked, and the first prize disk and the second prize disk are visible to the user.

While certain embodiments described below are directed to a primary game, such as a reel game including a plurality of reels associated with variable locations of symbol display positions, it should be appreciated that such embodiments may additionally or alternatively be employed in association with a secondary game, such as a bonus game including a plurality of reels associated with variable locations of reels at symbol display positions. Additionally, while the player's credit balance, the player's wager, and any awards are displayed as an amount of monetary credits or currency in certain of the embodiments described below, one or more of such player's credit balance, such player's wager, and any awards provided to such a player may be for non-monetary credits, promotional credits, and/or player tracking points or credits.

Furthermore, the term "EGM" is used herein to refer to any suitable electronic gaming machine which enables a player to play one or more games, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

### EGM Components

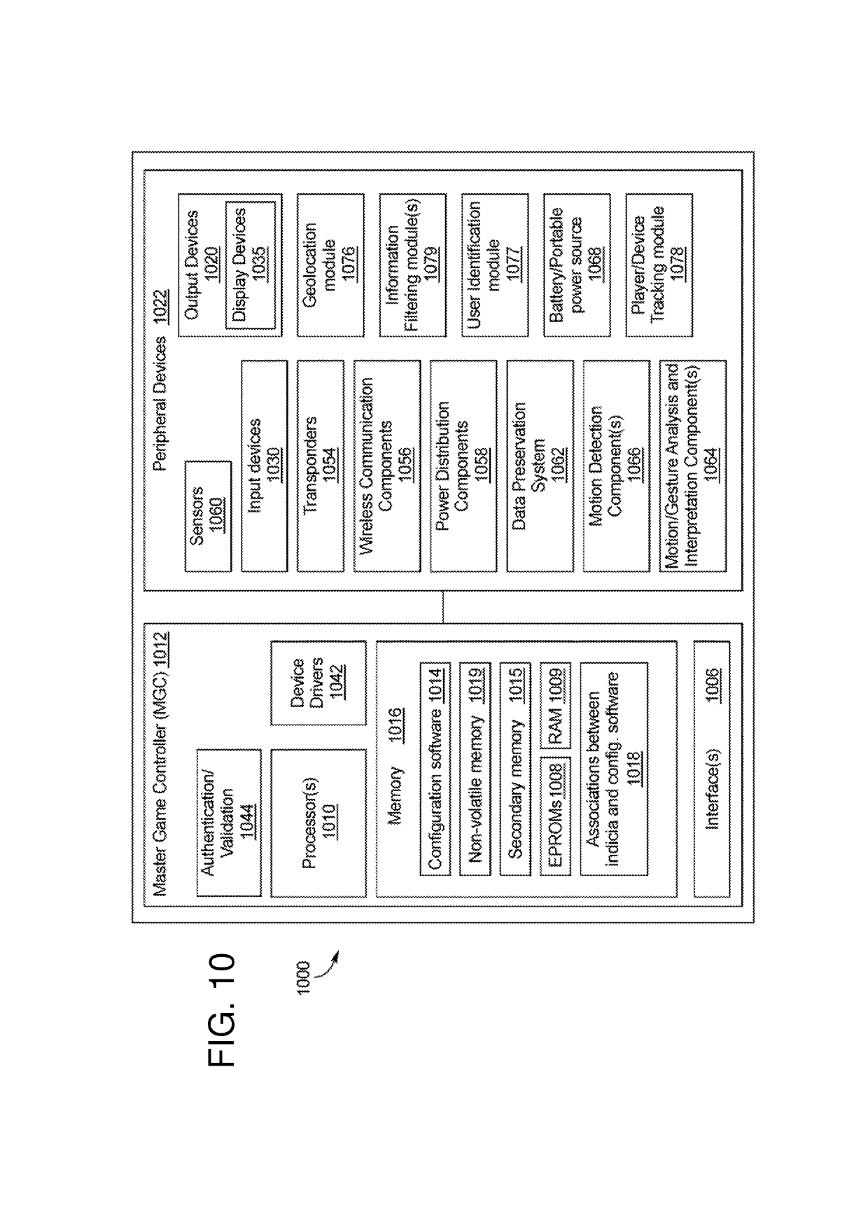

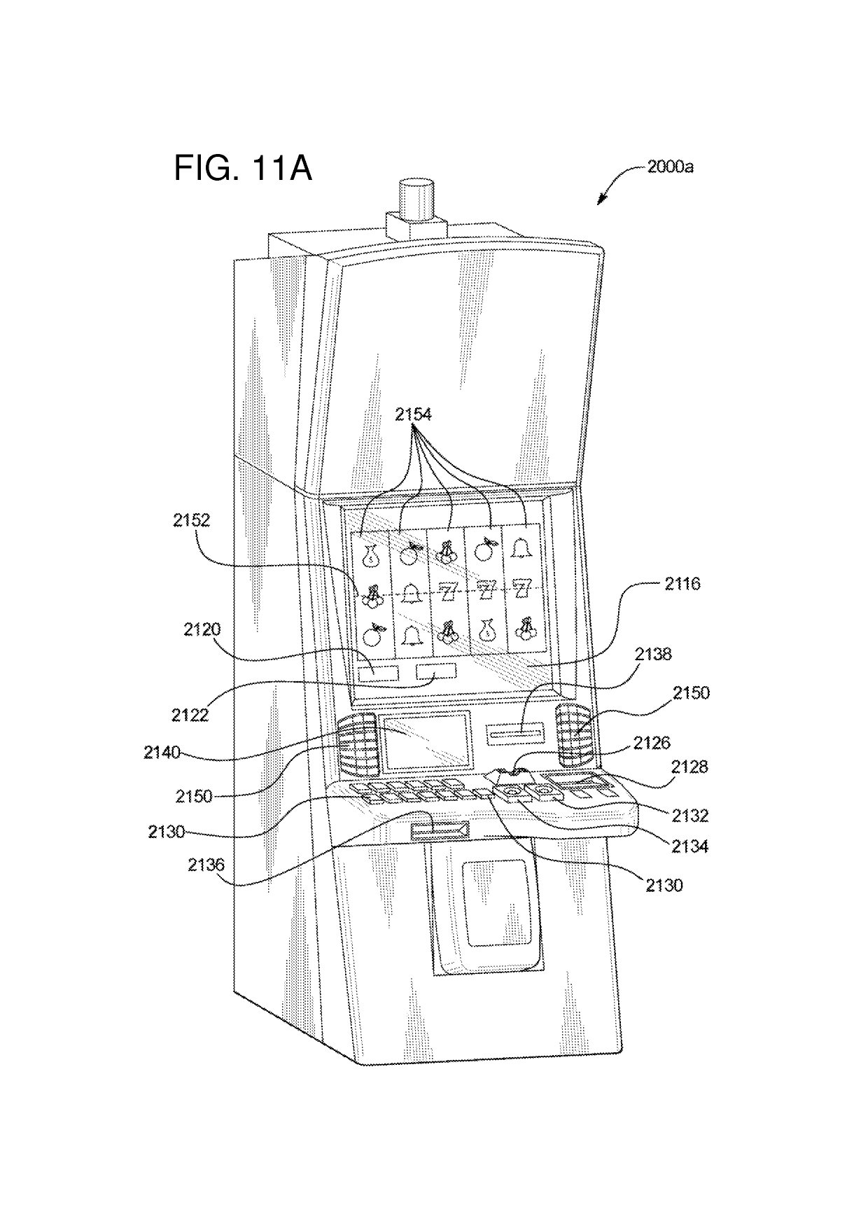

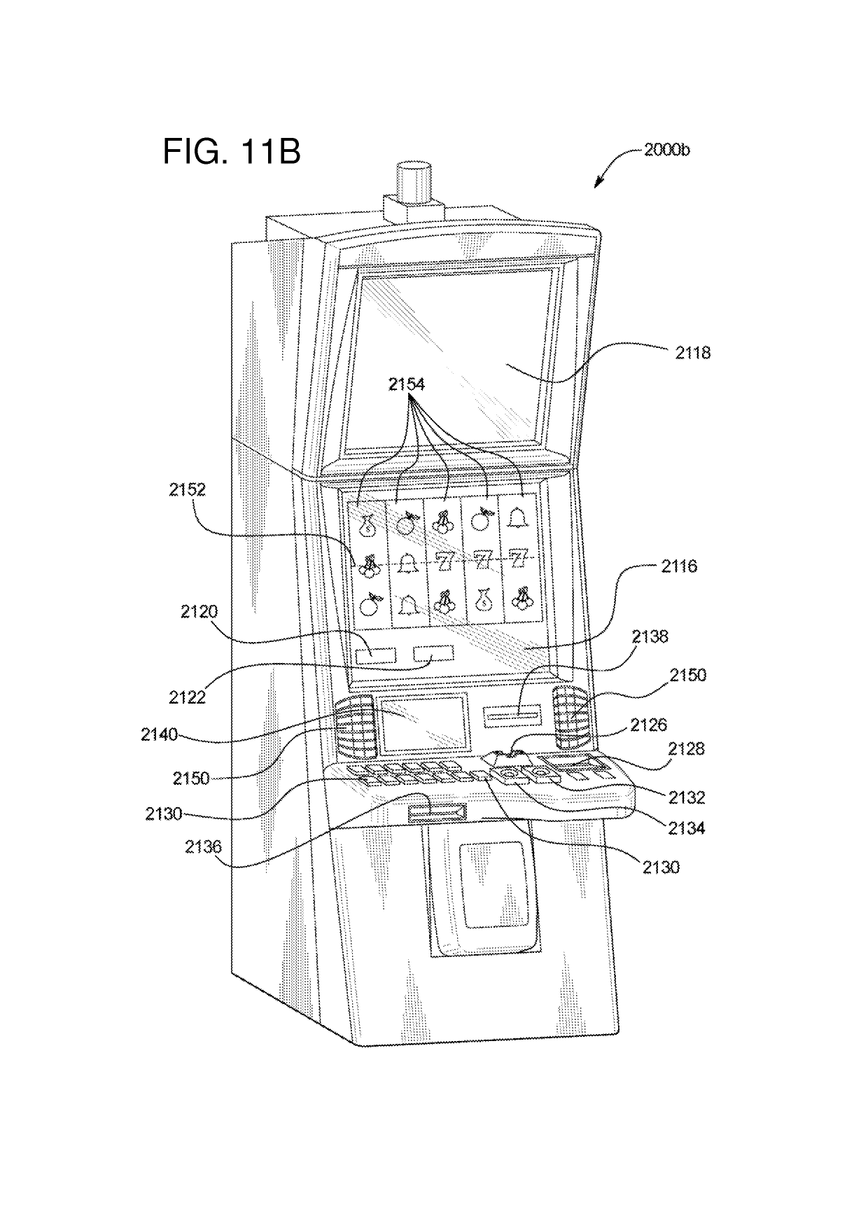

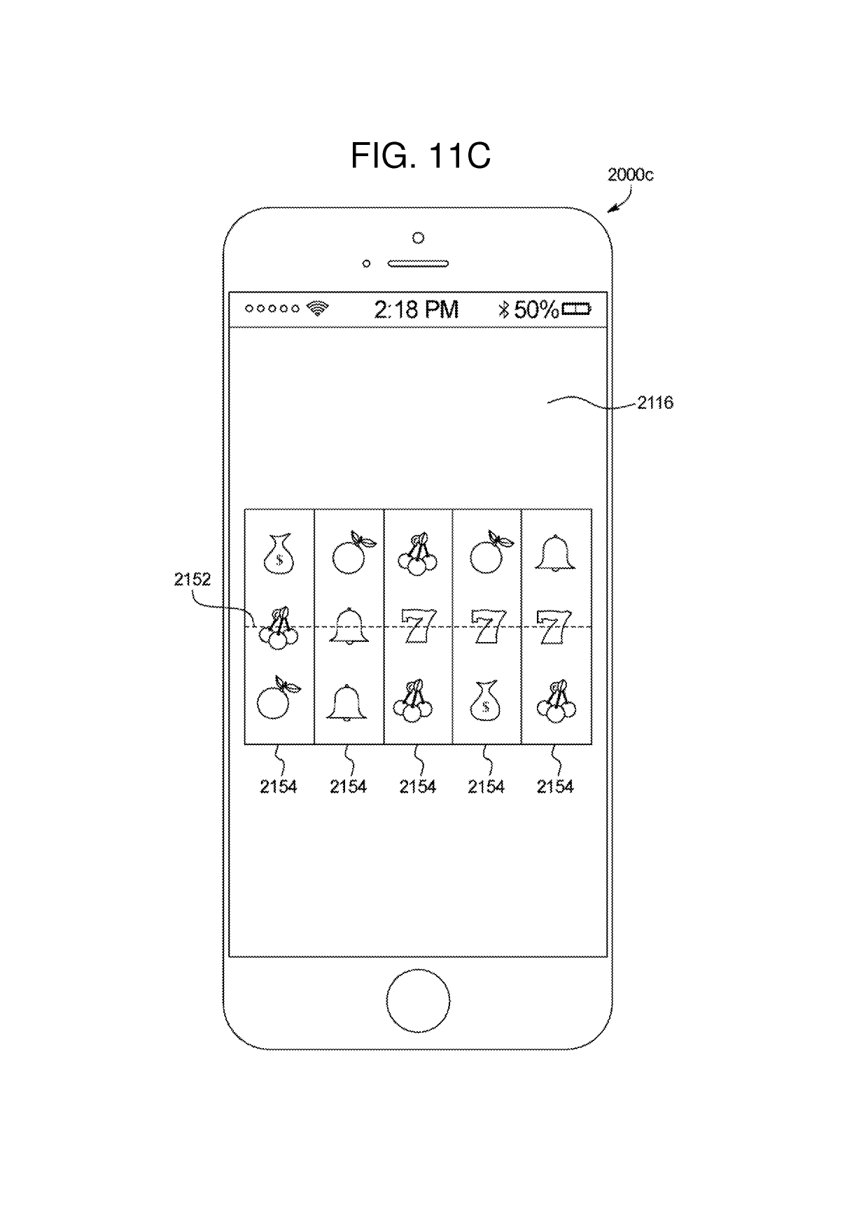

FIG. 10 is a block diagram of an example EGM 1000 and FIGS. 11A and 11B include two different example EGMs 2000a and 2000b. The EGMs 1000, 2000a, and 2000b are merely example EGMs, and different EGMs may be implemented using different combinations of the components shown in the EGMs 1000, 2000a, and 2000b. Although the below refers to EGMs, in various embodiments personal gaming devices (such as personal gaming device 2000c of FIG. 11C) may include some or all of the below components.

In these embodiments, the EGM 1000 includes a master gaming controller 1012 configured to communicate with and to operate with a plurality of peripheral devices 1022.

The master gaming controller 1012 includes at least one processor 1010. The at least one processor 1010 is any suitable processing device or set of processing devices, such as a microprocessor, a microcontroller-based platform, a suitable integrated circuit, or one or more application-specific integrated circuits (ASICs), configured to execute software enabling various configuration and reconfiguration tasks, such as: (1) communicating with a remote source (such as a server that stores authentication information or game information) via a communication interface 1006 of the master gaming controller 1012; (2) converting signals read by an interface to a format corresponding to that used by software or memory of the EGM; (3) accessing memory to configure or reconfigure game parameters in the memory according to indicia read from the EGM; (4) communicating with interfaces and the peripheral devices 1022 (such as input/output devices); and/or (5) controlling the peripheral devices 1022. In certain embodiments, one or more components of the master gaming controller 1012 (such as the at least one processor 1010) reside within a housing of the EGM (described below), while in other embodiments at least one component of the master gaming controller 1012 resides outside of the housing of the EGM.

The master gaming controller 1012 also includes at least one memory device 1016, which includes: (1) volatile memory (e.g., RAM 1009, which can include non-volatile RAM, magnetic RAM, ferroelectric RAM, and any other suitable forms); (2) non-volatile memory 1019 (e.g., disk memory, FLASH memory, EPROMs, EEPROMs, memristor-based non-volatile solid-state memory, etc.); (3) unalterable memory (e.g., EPROMs 1008); (4) read-only memory; and/or (5) a secondary memory storage device 1015, such as a non-volatile memory device, configured to store gaming software related information (the gaming software related information and the memory may be used to store various audio files and games not currently being used and invoked in a configuration or reconfiguration). Any other suitable magnetic, optical, and/or semiconductor memory may operate in conjunction with the EGM disclosed herein. In certain embodiments, the at least one memory device 1016 resides within the housing of the EGM (described below), while in other embodiments at least one component of the at least one memory device 1016 resides outside of the housing of the EGM. In these embodiments, any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

The at least one memory device 1016 is configured to store, for example: (1) configuration software 1014, such as all the parameters and settings for a game playable on the EGM; (2) associations 1018 between configuration indicia read from an EGM with one or more parameters and settings; (3) communication protocols configured to enable the at least one processor 1010 to communicate with the peripheral devices 1022; and/or (4) communication transport protocols (such as TCP/IP, USB, Firewire, IEEE1394, Bluetooth, IEEE 802.11x (IEEE 802.11 standards), hiperlan/2, HomeRF, etc.) configured to enable the EGM to communicate with local and non-local devices using such protocols. In one implementation, the master gaming controller 1012 communicates with other devices using a serial communication protocol. A few non-limiting examples of serial communication protocols that other devices, such as peripherals (e.g., a bill validator or a ticket printer), may use to communicate with the master game controller 1012 include USB, RS-232, and Netplex (a proprietary protocol developed by IGT).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a "circuit," "module," "component," or "system." Furthermore, aspects of the present disclosure may take the form of a computer program product embodied in one or more computer readable media having computer readable program code embodied thereon.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the player's computer, partly on the player's computer, as a stand-alone software package, partly on the player's computer and partly on a remote computer or entirely on the remote computer or server. In the latter scenario, the remote computer may be connected to the player's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

In certain embodiments, the at least one memory device 1016 is configured to store program code and instructions executable by the at least one processor of the EGM to control the EGM. The at least one memory device 1016 of the EGM also stores other operating data, such as image data, event data, input data, random number generators (RNGs) or pseudo-RNGs, paytable data or information, and/or applicable game rules that relate to the play of one or more games on the EGM. In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium. In certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an Internet or intranet).

The at least one memory device 1016 also stores a plurality of device drivers 1042. Examples of different types of device drivers include device drivers for EGM components and device drivers for the peripheral components 1022. Typically, the device drivers 1042 utilize various communication protocols that enable communication with a particular physical device. The device driver abstracts the hardware implementation of that device. For example, a device driver may be written for each type of card reader that could potentially be connected to the EGM. Non-limiting examples of communication protocols used to implement the device drivers include Netplex, USB, Serial, Ethernet 175, Firewire, I/O debouncer, direct memory map, serial, PCI, parallel, RF, Bluetooth.TM., near-field communications (e.g., using near-field magnetics), 802.11 (WiFi), etc. In one embodiment, when one type of a particular device is exchanged for another type of the particular device, the at least one processor of the EGM loads the new device driver from the at least one memory device to enable communication with the new device. For instance, one type of card reader in the EGM can be replaced with a second different type of card reader when device drivers for both card readers are stored in the at least one memory device.

In certain embodiments, the software units stored in the at least one memory device 1016 can be upgraded as needed. For instance, when the at least one memory device 1016 is a hard drive, new games, new game options, new parameters, new settings for existing parameters, new settings for new parameters, new device drivers, and new communication protocols can be uploaded to the at least one memory device 1016 from the master game controller 1012 or from some other external device. As another example, when the at least one memory device 1016 includes a CD/DVD drive including a CD/DVD configured to store game options, parameters, and settings, the software stored in the at least one memory device 1016 can be upgraded by replacing a first CD/DVD with a second CD/DVD. In yet another example, when the at least one memory device 1016 uses flash memory 1019 or EPROM 1008 units configured to store games, game options, parameters, and settings, the software stored in the flash and/or EPROM memory units can be upgraded by replacing one or more memory units with new memory units that include the upgraded software. In another embodiment, one or more of the memory devices, such as the hard drive, may be employed in a game software download process from a remote software server.

In some embodiments, the at least one memory device 1016 also stores authentication and/or validation components 1044 configured to authenticate/validate specified EGM components and/or information, such as hardware components, software components, firmware components, peripheral device components, player input device components, information received from one or more player input devices, information stored in the at least one memory device 1016, etc.

In certain embodiments, the peripheral devices 1022 include several device interfaces, such as: (1) at least one output device 1020 including at least one display device 1035; (2) at least one input device 1030 (which may include contact and/or non-contact interfaces); (3) at least one transponder 1054; (4) at least one wireless communication component 1056; (5) at least one wired/wireless power distribution component 1058; (6) at least one sensor 1060; (7) at least one data preservation component 1062; (8) at least one motion/gesture analysis and interpretation component 1064; (9) at least one motion detection component 1066; (10) at least one portable power source 1068; (11) at least one geolocation module 1076; (12) at least one player identification module 1077; (13) at least one player/device tracking module 1078; and (14) at least one information filtering module 1079.

The at least one output device 1020 includes at least one display device 1035 configured to display any game(s) displayed by the EGM and any suitable information associated with such game(s). In certain embodiments, the display devices are connected to or mounted on a housing of the EGM (described below). In various embodiments, the display devices serve as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantity of credits, amount of cash, account balance, or the equivalent; and (e) a bet display configured to display an amount wagered for one or more plays of one or more games. The example EGM 2000a illustrated in FIG. 11A includes a central display device 2116, a player tracking display 2140, a credit display 2120, and a bet display 2122. The example EGM 2000b illustrated in FIG. 11B includes a central display device 2116, an upper display device 2118, a player tracking display 2140, a credit display 2120, and a bet display 2122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display device includes a touch-screen with an associated touch-screen controller. The display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, the at least one output device 1020 includes a payout device. In these embodiments, after the EGM receives an actuation of a cashout device (described below), the EGM causes the payout device to provide a payment to the player. In one embodiment, the payout device is one or more of: (a) a ticket printer and dispenser configured to print and dispense a ticket or credit slip associated with a monetary value, wherein the ticket or credit slip may be redeemed for its monetary value via a cashier, a kiosk, or other suitable redemption system; (b) a bill dispenser configured to dispense paper currency; (c) a coin dispenser configured to dispense coins or tokens (such as into a coin payout tray); and (d) any suitable combination thereof. The example EGMs 2000a and 2000b illustrated in FIGS. 5A and 5B each include a ticket printer and dispenser 2136.

In certain embodiments, rather than dispensing bills, coins, or a physical ticket having a monetary value to the player following receipt of an actuation of the cashout device, the payout device is configured to cause a payment to be provided to the player in the form of an electronic funds transfer, such as via a direct deposit into a bank account, a casino account, or a prepaid account of the player; via a transfer of funds onto an electronically recordable identification card or smart card of the player; or via sending a virtual ticket having a monetary value to an electronic device of the player.

While any credit balances, any wagers, any values, and any awards are described herein as amounts of monetary credits or currency, one or more of such credit balances, such wagers, such values, and such awards may be for non-monetary credits, promotional credits, of player tracking points or credits.

In certain embodiments, the at least one output device 1020 is a sound generating device controlled by one or more sound cards. In one such embodiment, the sound generating device includes one or more speakers or other sound generating hardware and/or software configured to generate sounds, such as by playing music for any games or by playing music for other modes of the EGM, such as an attract mode. The example EGMs 2000a and 2000b illustrated in FIGS. 5A and 5B each include a plurality of speakers 2150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

The at least one input device 1030 may include any suitable device that enables an input signal to be produced and received by the at least one processor 1010 of the EGM.

In one embodiment, the at least one input device 1030 includes a payment device configured to communicate with the at least one processor of the EGM to fund the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader into which a player identification card is inserted to fund the EGM; or (f) any suitable combination thereof. The example EGMs 2000a and 2000b illustrated in FIGS. 5A and 5B each include a combined bill and ticket acceptor 2128 and a coin slot 2126.

In one embodiment, the at least one input device 1030 includes a payment device configured to enable the EGM to be funded via an electronic funds transfer, such as a transfer of funds from a bank account. In another embodiment, the EGM includes a payment device configured to communicate with a mobile device of a player, such as a mobile phone, a radio frequency identification tag, or any other suitable wired or wireless device, to retrieve relevant information associated with that player to fund the EGM. When the EGM is funded, the at least one processor determines the amount of funds entered and displays the corresponding amount on a credit display or any other suitable display as described below.

In certain embodiments, the at least one input device 1030 includes at least one wagering or betting device. In various embodiments, the one or more wagering or betting devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). One such wagering or betting device is as a maximum wager or bet device that, when actuated, causes the EGM to place a maximum wager on a play of a game. Another such wagering or betting device is a repeat bet device that, when actuated, causes the EGM to place a wager that is equal to the previously-placed wager on a play of a game. A further such wagering or betting device is a bet one device that, when actuated, causes the EGM to increase the wager by one credit. Generally, upon actuation of one of the wagering or betting devices, the quantity of credits displayed in a credit meter (described below) decreases by the amount of credits wagered, while the quantity of credits displayed in a bet display (described below) increases by the amount of credits wagered.

In various embodiments, the at least one input device 1030 includes at least one game play activation device. In various embodiments, the one or more game play initiation devices are each: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). After a player appropriately funds the EGM and places a wager, the EGM activates the game play activation device to enable the player to actuate the game play activation device to initiate a play of a game on the EGM (or another suitable sequence of events associated with the EGM). After the EGM receives an actuation of the game play activation device, the EGM initiates the play of the game. The example EGMs 2000a and 2000b illustrated in FIGS. 5A and 5B each include a game play activation device in the form of a game play initiation button 2132. In other embodiments, the EGM begins game play automatically upon appropriate funding rather than upon utilization of the game play activation device.

In other embodiments, the at least one input device 1030 includes a cashout device. In various embodiments, the cashout device is: (1) a mechanical button supported by the housing of the EGM (such as a hard key or a programmable soft key), or (2) an icon displayed on a display device of the EGM (described below) that is actuatable via a touch screen of the EGM (described below) or via use of a suitable input device of the EGM (such as a mouse or a joystick). When the EGM receives an actuation of the cashout device from a player and the player has a positive (i.e., greater-than-zero) credit balance, the EGM initiates a payout associated with the player's credit balance. The example EGMs 2000a and 2000b illustrated in FIGS. 5A and 5B each include a cashout device in the form of a cashout button 2134.

In various embodiments, the at least one input device 1030 includes a plurality of buttons that are programmable by the EGM operator to, when actuated, cause the EGM to perform particular functions. For instance, such buttons may be hard keys, programmable soft keys, or icons icon displayed on a display device of the EGM (described below) that are actuatable via a touch screen of the EGM (described below) or via use of a suitable input device of the EGM (such as a mouse or a joystick). The example EGMs 2000a and 2000b illustrated in FIGS. 5A and 5B each include a plurality of such buttons 2130.

In certain embodiments, the at least one input device 1030 includes a touch-screen coupled to a touch-screen controller or other touch-sensitive display overlay to enable interaction with any images displayed on a display device (as described below). One such input device is a conventional touch-screen button panel. The touch-screen and the touch-screen controller are connected to a video controller. In these embodiments, signals are input to the EGM by touching the touch screen at the appropriate locations.

In embodiments including a player tracking system, as further described below, the at least one input device 1030 includes a card reader in communication with the at least one processor of the EGM. The example EGMs 2000a and 2000b illustrated in FIGS. 5A and 5B each include a card reader 2138. The card reader is configured to read a player identification card inserted into the card reader.

The at least one wireless communication component 1056 includes one or more communication interfaces having different architectures and utilizing a variety of protocols, such as (but not limited to) 802.11 (WiFi); 802.15 (including Bluetooth.TM.); 802.16 (WiMax); 802.22; cellular standards such as CDMA, CDMA2000, and WCDMA; Radio Frequency (e.g., RFID); infrared; and Near Field Magnetic communication protocols. The at least one wireless communication component 1056 transmits electrical, electromagnetic, or optical signals that carry digital data streams or analog signals representing various types of information.

The at least one wired/wireless power distribution component 1058 includes components or devices that are configured to provide power to other devices. For example, in one embodiment, the at least one power distribution component 1058 includes a magnetic induction system that is configured to provide wireless power to one or more player input devices near the EGM. In one embodiment, a player input device docking region is provided, and includes a power distribution component that is configured to recharge a player input device without requiring metal-to-metal contact. In one embodiment, the at least one power distribution component 1058 is configured to distribute power to one or more internal components of the EGM, such as one or more rechargeable power sources (e.g., rechargeable batteries) located at the EGM.

In certain embodiments, the at least one sensor 1060 includes at least one of: optical sensors, pressure sensors, RF sensors, infrared sensors, image sensors, thermal sensors, and biometric sensors. The at least one sensor 1060 may be used for a variety of functions, such as: detecting movements and/or gestures of various objects within a predetermined proximity to the EGM; detecting the presence and/or identity of various persons (e.g., players, casino employees, etc.), devices (e.g., player input devices), and/or systems within a predetermined proximity to the EGM.

The at least one data preservation component 1062 is configured to detect or sense one or more events and/or conditions that, for example, may result in damage to the EGM and/or that may result in loss of information associated with the EGM. Additionally, the data preservation system 1062 may be operable to initiate one or more appropriate action(s) in response to the detection of such events/conditions.

The at least one motion/gesture analysis and interpretation component 1064 is configured to analyze and/or interpret information relating to detected player movements and/or gestures to determine appropriate player input information relating to the detected player movements and/or gestures. For example, in one embodiment, the at least one motion/gesture analysis and interpretation component 1064 is configured to perform one or more of the following functions: analyze the detected gross motion or gestures of a player; interpret the player's motion or gestures (e.g., in the context of a casino game being played) to identify instructions or input from the player; utilize the interpreted instructions/input to advance the game state; etc. In other embodiments, at least a portion of these additional functions may be implemented at a remote system or device.

The at least one portable power source 1068 enables the EGM to operate in a mobile environment. For example, in one embodiment, the EGM 300 includes one or more rechargeable batteries.

The at least one geolocation module 1076 is configured to acquire geolocation information from one or more remote sources and use the acquired geolocation information to determine information relating to a relative and/or absolute position of the EGM. For example, in one implementation, the at least one geolocation module 1076 is configured to receive GPS signal information for use in determining the position or location of the EGM. In another implementation, the at least one geolocation module 1076 is configured to receive multiple wireless signals from multiple remote devices (e.g., EGMs, servers, wireless access points, etc.) and use the signal information to compute position/location information relating to the position or location of the EGM.

The at least one player identification module 1077 is configured to determine the identity of the current player or current owner of the EGM. For example, in one embodiment, the current player is required to perform a login process at the EGM in order to access one or more features. Alternatively, the EGM is configured to automatically determine the identity of the current player based on one or more external signals, such as an RFID tag or badge worn by the current player and that provides a wireless signal to the EGM that is used to determine the identity of the current player. In at least one embodiment, various security features are incorporated into the EGM to prevent unauthorized players from accessing confidential or sensitive information.

The at least one information filtering module 1079 is configured to perform filtering (e.g., based on specified criteria) of selected information to be displayed at one or more displays 1035 of the EGM.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumbsticks, ticket readers, touch screens, trackballs, touchpads, wheels, and wireless communication devices.

As generally described above, in certain embodiments, such as the example EGMs 2000a and 2000b illustrated in FIGS. 5A and 5B, the EGM has a support structure, housing, or cabinet that provides support for a plurality of the input devices and the output devices of the EGM. Further, the EGM is configured such that a player may operate it while standing or sitting. In various embodiments, the EGM is positioned on a base or stand, or is configured as a pub-style tabletop game (not shown) that a player may operate typically while sitting. As illustrated by the different example EGMs 2000a and 2000b shown in FIGS. 5A and 5B, EGMs may have varying housing and display configurations.

In certain embodiments, the EGM is a device that has obtained approval from a regulatory gaming commission, and in other embodiments, the EGM is a device that has not obtained approval from a regulatory gaming commission.

The EGMs described above are merely three examples of different types of EGMs. Certain of these example EGMs may include one or more elements that may not be included in all gaming systems, and these example EGMs may not include one or more elements that are included in other gaming systems. For example, certain EGMs include a coin acceptor while others do not.

### Operation of Primary or Base Games and/or Secondary or Bonus Games

In various embodiments, an EGM may be implemented in one of a variety of different configurations. In various embodiments, the EGM may be implemented as one of: (a) a dedicated EGM in which computerized game programs executable by the EGM for controlling any primary or base games (referred to herein as "primary games") and/or any secondary or bonus games or other functions (referred to herein as "secondary games") displayed by the EGM are provided with the EGM before delivery to a gaming establishment or before being provided to a player; and (b) a changeable EGM in which computerized game programs executable by the EGM for controlling any primary games and/or secondary games displayed by the EGM are downloadable or otherwise transferred to the EGM through a data network or remote communication link; from a USB drive, flash memory card, or other suitable memory device; or in any other suitable manner after the EGM is physically located in a gaming establishment or after the EGM is provided to a player.

As generally explained above, in various embodiments in which the gaming system includes a central server, central controller, or remote host and a changeable EGM, the at least one memory device of the central server, central controller, or remote host stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the central server, central controller, or remote host is configured to communicate one or more of the stored executable game programs to the at least one processor of the changeable EGM. In different embodiments, a stored executable game program is communicated or delivered to the at least one processor of the changeable EGM by: (a) embedding the executable game program in a device or a component (such as a microchip to be inserted into the changeable EGM); (b) writing the executable game program onto a disc or other media; or (c) uploading or streaming the executable game program over a data network (such as a dedicated data network). After the executable game program is communicated from the central server, central controller, or remote host to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request. The gaming system provides the selected game outcome and/or award.

In certain embodiments, the gaming system determines a predetermined game outcome and/or award based on the results of a bingo, keno, or lottery game. In certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card. If the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards.

In certain embodiments in which the gaming system includes a central server, central controller, or remote host and an EGM, the EGM is configured to communicate with the central server, central controller, or remote host for monitoring purposes only. In such embodiments, the EGM determines the game outcome(s) and/or award(s) to be provided in any of the manners described above, and the central server, central controller, or remote host monitors the activities and events occurring on the EGM. In one such embodiment, the gaming system includes a real-time or online accounting and gaming information system configured to communicate with the central server, central controller, or remote host. In this embodiment, the accounting and gaming information system includes: (a) a player database configured to store player profiles, (b) a player tracking module configured to track players (as described below), and (c) a credit system configured to provide automated transactions.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reel type game, the gaming system includes one or more reels in either an electromechanical form with mechanical rotating reels or in a video form with simulated reels and movement thereof. Each reel displays a plurality of indicia or symbols, such as bells, hearts, fruits, numbers, letters, bars, or other images that typically correspond to a theme associated with the gaming system. In certain such embodiments, the gaming system includes one or more paylines associated with the reels. The example EGM 2000b shown in FIG. 5B includes a payline 2152 and a plurality of reels 2154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side or sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided.

In various embodiments, the gaming system includes a progressive award. Typically, a progressive award includes an initial amount and an additional amount funded through a portion of each wager placed to initiate a play of a primary game. When one or more triggering events occurs, the gaming system provides at least a portion of the progressive award. After the gaming system provides the progressive award, an amount of the progressive award is reset to the initial amount and a portion of each subsequent wager is allocated to the next progressive award.

As generally noted above, in addition to providing winning credits or other awards for one or more plays of the primary game(s), in various embodiments the gaming system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary game(s) provides a greater expectation of winning than the primary game(s) and is accompanied with more attractive or unusual features than the primary game(s). The secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a "BONUS" symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. Any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for providing the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a "secondary game meter" configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments, entry must be won or earned through play of the primary game, thereby encouraging play of the primary game. In other embodiments, qualification for the secondary game is accomplished through a simple "buy-in." For example, qualification through other specified activities is unsuccessful, payment of a fee or placement of an additional wager "buys-in" to the secondary game. In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment. In certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment, the EGMs enable the players of those EGMs to participate in one or more gaming tournaments for one or more awards.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a mobile phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device.

### Web-Based Gaming

In various embodiments, the gaming system includes one or more servers configured to communicate with a personal gaming device--such as a smartphone, a tablet computer, a desktop computer, or a laptop computer--to enable web-based game play using the personal gaming device. In various embodiments, the player must first access a gaming website via an Internet browser of the personal gaming device or execute an application (commonly called an "app") installed on the personal gaming device before the player can use the personal gaming device to participate in web-based game play. In certain embodiments, the one or more servers and the personal gaming device operate in a thin-client environment. In these embodiments, the personal gaming device receives inputs via one or more input devices (such as a touch screen and/or physical buttons), the personal gaming device sends the received inputs to the one or more servers, the one or more servers make various determinations based on the inputs and determine content to be displayed (such as a randomly determined game outcome and corresponding award), the one or more servers send the content to the personal gaming device, and the personal gaming device displays the content.

In certain such embodiments, the one or more servers must identify the player before enabling game play on the personal gaming device (or, in some embodiments, before enabling monetary wager-based game play on the personal gaming device). In these embodiments, the player must identify herself to the one or more servers, such as by inputting the player's unique player name and password combination, providing an input to a biometric sensor (e.g., a fingerprint sensor, a retinal sensor, a voice sensor, or a facial-recognition sensor), or providing any other suitable information.

Once identified, the one or more servers enable the player to establish an account balance from which the player can draw credits usable to wager on plays of a game. In certain embodiments, the one or more servers enable the player to initiate an electronic funds transfer to transfer funds from a bank account to the player's account balance. In other embodiments, the one or more servers enable the player to make a payment using the player's credit card, debit card, or other suitable device to add money to the player's account balance. In other embodiments, the one or more servers enable the player to add money to the player's account balance via a peer-to-peer type application, such as PayPal or Venmo. The one or more servers also enable the player to cash out the player's account balance (or part of it) in any suitable manner, such as via an electronic funds transfer, by initiating creation of a paper check that is mailed to the player, or by initiating printing of a voucher at a kiosk in a gaming establishment.

In certain embodiments, the one or more servers include a payment server that handles establishing and cashing out players' account balances and a separate game server configured to determine the outcome and any associated award for a play of a game. In these embodiments, the game server is configured to communicate with the personal gaming device and the payment device, and the personal gaming device and the payment device are not configured to directly communicate with one another. In these embodiments, when the game server receives data representing a request to start a play of a game at a desired wager, the game server sends data representing the desired wager to the payment server. The payment server determines whether the player's account balance can cover the desired wager (i.e., includes a monetary balance at least equal to the desired wager).

If the payment server determines that the player's account balance cannot cover the desired wager, the payment server notifies the game server, which then instructs the personal gaming device to display a suitable notification to the player that the player's account balance is too low to place the desired wager. If the payment server determines that the player's account balance can cover the desired wager, the payment server deducts the desired wager from the account balance and notifies the game server. The game server then determines an outcome and any associated award for the play of the game. The game server notifies the payment server of any nonzero award, and the payment server increases the player's account balance by the nonzero award. The game server sends data representing the outcome and any award to the personal gaming device, which displays the outcome and any award.

In certain embodiments, the one or more servers enable web-based game play using a personal gaming device only if the personal gaming device satisfies one or more jurisdictional requirements. In one embodiment, the one or more servers enable web-based game play using the personal gaming device only if the personal gaming device is located within a designated geographic area (such as within certain state or county lines or within the boundaries of a gaming establishment). In this embodiment, the geolocation module of the personal gaming device determines the location of the personal gaming device and sends the location to the one or more servers, which determine whether the personal gaming device is located within the designated geographic area. In various embodiments, the one or more servers enable non-monetary wager-based game play if the personal gaming device is located outside of the designated geographic area.

In various embodiments, the gaming system includes an EGM configured to communicate with a personal gaming device--such as a smartphone, a tablet computer, a desktop computer, or a laptop computer--to enable tethered mobile game play using the personal gaming device. Generally, in these embodiments, the EGM establishes communication with the personal gaming device and enables the player to play games on the EGM remotely via the personal gaming device. In certain embodiments, the gaming system includes a geo-fence system that enables tethered game play within a particular geographic area but not outside of that geographic area.

### Social Network Integration

In certain embodiments, the gaming system is configured to communicate with a social network server that hosts or partially hosts a social networking website via a data network (such as the Internet) to integrate a player's gaming experience with the player's social networking account. This enables the gaming system to send certain information to the social network server that the social network server can use to create content (such as text, an image, and/or a video) and post it to the player's wall, newsfeed, or similar area of the social networking website accessible by the player's connections (and in certain cases the public) such that the player's connections can view that information. This also enables the gaming system to receive certain information from the social network server, such as the player's likes or dislikes or the player's list of connections. In certain embodiments, the gaming system enables the player to link the player's player account to the player's social networking account(s). This enables the gaming system to, once it identifies the player and initiates a gaming session (such as via the player logging in to a website (or an application) on the player's personal gaming device or via the player inserting the player's player tracking card into an EGM), link that gaming session to the player's social networking account(s). In other embodiments, the gaming system enables the player to link the player's social networking account(s) to individual gaming sessions when desired by providing the required login information.

For instance, in one embodiment, if a player wins a particular award (e.g., a progressive award or a jackpot award) or an award that exceeds a certain threshold (e.g., an award exceeding $1,000), the gaming system sends information about the award to the social network server to enable the server to create associated content (such as a screenshot of the outcome and associated award) and to post that content to the player's wall (or other suitable area) of the social networking website for the player's connections to see (and to entice them to play). In another embodiment, if a player joins a multiplayer game and there is another seat available, the gaming system sends that information to the social network sever to enable the server to create associated content (such as text indicating a vacancy for that particular game) and to post that content to the player's wall (or other suitable area) of the social networking website for the player's connections to see (and to entice them to fill the vacancy). In another embodiment, if the player consents, the gaming system sends advertisement information or offer information to the social network server to enable the social network server to create associated content (such as text or an image reflecting an advertisement and/or an offer) and to post that content to the player's wall (or other suitable area) of the social networking website for the player's connections to see. In another embodiment, the gaming system enables the player to recommend a game to the player's connections by posting a recommendation to the player's wall (or other suitable area) of the social networking website.

### Differentiating Certain Gaming Systems from General Purpose Computing Devices

Certain of the gaming systems described herein, such as EGMs located in a casino or another gaming establishment, include certain components and/or are configured to operate in certain manners that differentiate these systems from general purpose computing devices, i.e., certain personal gaming devices such as desktop computers and laptop computers.

For instance, EGMs are highly regulated to ensure fairness and, in many cases, EGMs are configured to award monetary awards up to multiple millions of dollars. To satisfy security and regulatory requirements in a gaming environment, hardware and/or software architectures are implemented in EGMs that differ significantly from those of general purpose computing devices. For purposes of illustration, a description of EGMs relative to general purpose computing devices and some examples of these additional (or different) hardware and/or software architectures found in EGMs are described below.

At first glance, one might think that adapting general purpose computing device technologies to the gaming industry and EGMs would be a simple proposition because both general purpose computing devices and EGMs employ processors that control a variety of devices. However, due to at least: (1) the regulatory requirements placed on EGMs, (2) the harsh environment in which EGMs operate, (3) security requirements, and (4) fault tolerance requirements, adapting general purpose computing device technologies to EGMs can be quite difficult. Further, techniques and methods for solving a problem in the general purpose computing device industry, such as device compatibility and connectivity issues, might not be adequate in the gaming industry. For instance, a fault or a weakness tolerated in a general purpose computing device, such as security holes in software or frequent crashes, is not tolerated in an EGM because in an EGM these faults can lead to a direct loss of funds from the EGM, such as stolen cash or loss of revenue when the EGM is not operating properly or when the random outcome determination is manipulated.

Certain differences between general purpose computing devices and EGMs are described below. A first difference between EGMs and general purpose computing devices is that EGMs are state-based systems. A state-based system stores and maintains its current state in a non-volatile memory such that, in the event of a power failure or other malfunction, the state-based system can return to that state when the power is restored or the malfunction is remedied. For instance, for a state-based EGM, if the EGM displays an award for a game of chance but the power to the EGM fails before the EGM provides the award to the player, the EGM stores the pre-power failure state in a non-volatile memory, returns to that state upon restoration of power, and provides the award to the player. This requirement affects the software and hardware design on EGMs. General purpose computing devices are not state-based machines, and a majority of data is usually lost when a malfunction occurs on a general purpose computing device.

A second difference between EGMs and general purpose computing devices is that, for regulatory purposes, the software on the EGM utilized to operate the EGM has been designed to be static and monolithic to prevent cheating by the operator of the EGM. For instance, one solution that has been employed in the gaming industry to prevent cheating and to satisfy regulatory requirements has been to manufacture an EGM that can use a proprietary processor running instructions to provide the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used to operate a device during generation of the game of chance, can require burning a new EPROM approved by the gaming jurisdiction and reinstalling the new EPROM on the EGM in the presence of a gaming regulator. Regardless of whether the EPROM solution is used, to gain approval in most gaming jurisdictions, an EGM must demonstrate sufficient safeguards that prevent an operator or a player of an EGM from manipulating the EGM's hardware and software in a manner that gives him an unfair, and in some cases illegal, advantage.

A third difference between EGMs and general purpose computing devices is authentication--EGMs storing code are configured to authenticate the code to determine if the code is unaltered before executing the code. If the code has been altered, the EGM prevents the code from being executed. The code authentication requirements in the gaming industry affect both hardware and software designs on EGMs. Certain EGMs use hash functions to authenticate code. For instance, one EGM stores game program code, a hash function, and an authentication hash (which may be encrypted). Before executing the game program code, the EGM hashes the game program code using the hash function to obtain a result hash and compares the result hash to the authentication hash. If the result hash matches the authentication hash, the EGM determines that the game program code is valid and executes the game program code. If the result hash does not match the authentication hash, the EGM determines that the game program code has been altered (i.e., may have been tampered with) and prevents execution of the game program code.

A fourth difference between EGMs and general purpose computing devices is that EGMs have unique peripheral device requirements that differ from those of a general purpose computing device, such as peripheral device security requirements not usually addressed by general purpose computing devices. For instance, monetary devices, such as coin dispensers, bill validators, and ticket printers and computing devices that are used to govern the input and output of cash or other items having monetary value (such as tickets) to and from an EGM have security requirements that are not typically addressed in general purpose computing devices. Therefore, many general purpose computing device techniques and methods developed to facilitate device connectivity and device compatibility do not address the emphasis placed on security in the gaming industry.

To address some of the issues described above, a number of hardware/software components and architectures are utilized in EGMs that are not typically found in general purpose computing devices. These hardware/software components and architectures, as described below in more detail, include but are not limited to watchdog timers, voltage monitoring systems, state-based software architecture and supporting hardware, specialized communication interfaces, security monitoring, and trusted memory.

Certain EGMs use a watchdog timer to provide a software failure detection mechanism. In a normally-operating EGM, the operating software periodically accesses control registers in the watchdog timer subsystem to "re-trigger" the watchdog. Should the operating software fail to access the control registers within a preset timeframe, the watchdog timer will timeout and generate a system reset. Typical watchdog timer circuits include a loadable timeout counter register to enable the operating software to set the timeout interval within a certain range of time. A differentiating feature of some circuits is that the operating software cannot completely disable the function of the watchdog timer. In other words, the watchdog timer always functions from the time power is applied to the board.

Certain EGMs use several power supply voltages to operate portions of the computer circuitry. These can be generated in a central power supply or locally on the computer board. If any of these voltages falls out of the tolerance limits of the circuitry they power, unpredictable operation of the EGM may result. Though most modern general purpose computing devices include voltage monitoring circuitry, these types of circuits only report voltage status to the operating software. Out of tolerance voltages can cause software malfunction, creating a potential uncontrolled condition in the general purpose computing device. Certain EGMs have power supplies with relatively tighter voltage margins than that required by the operating circuitry. In addition, the voltage monitoring circuitry implemented in certain EGMs typically has two thresholds of control. The first threshold generates a software event that can be detected by the operating software and an error condition then generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the EGM.

As described above, certain EGMs are state-based machines. Different functions of the game provided by the EGM (e.g., bet, play, result, points in the graphical presentation, etc.) may be defined as a state. When the EGM moves a game from one state to another, the EGM stores critical data regarding the game software in a custom non-volatile memory subsystem. This ensures that the player's wager and credits are preserved and to minimize potential disputes in the event of a malfunction on the EGM. In general, the EGM does not advance from a first state to a second state until critical information that enables the first state to be reconstructed has been stored. This feature enables the EGM to recover operation to the current state of play in the event of a malfunction, loss of power, etc. that occurred just before the malfunction. In at least one embodiment, the EGM is configured to store such critical information using atomic transactions.

Generally, an atomic operation in computer science refers to a set of operations that can be combined so that they appear to the rest of the system to be a single operation with only two possible outcomes: success or failure. As related to data storage, an atomic transaction may be characterized as series of database operations which either all occur, or all do not occur. A guarantee of atomicity prevents updates to the database occurring only partially, which can result in data corruption.

To ensure the success of atomic transactions relating to critical information to be stored in the EGM memory before a failure event (e.g., malfunction, loss of power, etc.), memory that includes one or more of the following criteria be used: direct memory access capability; data read/write capability which meets or exceeds minimum read/write access characteristics (such as at least 5.08 Mbytes/sec (Read) and/or at least 38.0 Mbytes/sec (Write)). Memory devices that meet or exceed the above criteria may be referred to as "fault-tolerant" memory devices.

Typically, battery-backed RAM devices may be configured to function as fault-tolerant devices according to the above criteria, whereas flash RAM and/or disk drive memory are typically not configurable to function as fault-tolerant devices according to the above criteria. Accordingly, battery-backed RAM devices are typically used to preserve EGM critical data, although other types of non-volatile memory devices may be employed. These memory devices are typically not used in typical general purpose computing devices.

Thus, in at least one embodiment, the EGM is configured to store critical information in fault-tolerant memory (e.g., battery-backed RAM devices) using atomic transactions. Further, in at least one embodiment, the fault-tolerant memory is able to successfully complete all desired atomic transactions (e.g., relating to the storage of EGM critical information) within a time period of 200 milliseconds or less. In at least one embodiment, the time period of 200 milliseconds represents a maximum amount of time for which sufficient power may be available to the various EGM components after a power outage event has occurred at the EGM.

As described previously, the EGM may not advance from a first state to a second state until critical information that enables the first state to be reconstructed has been atomically stored. After the state of the EGM is restored during the play of a game of chance, game play may resume and the game may be completed in a manner that is no different than if the malfunction had not occurred. Thus, for example, when a malfunction occurs during a game of chance, the EGM may be restored to a state in the game of chance just before when the malfunction occurred. The restored state may include metering information and graphical information that was displayed on the EGM in the state before the malfunction. For example, when the malfunction occurs during the play of a card game after the cards have been dealt, the EGM may be restored with the cards that were previously displayed as part of the card game. As another example, a bonus game may be triggered during the play of a game of chance in which a player is required to make a number of selections on a video display screen. When a malfunction has occurred after the player has made one or more selections, the EGM may be restored to a state that shows the graphical presentation just before the malfunction including an indication of selections that have already been made by the player. In general, the EGM may be restored to any state in a plurality of states that occur in the game of chance that occurs while the game of chance is played or to states that occur between the play of a game of chance.

Game history information regarding previous games played such as an amount wagered, the outcome of the game, and the like may also be stored in a non-volatile memory device. The information stored in the non-volatile memory may be detailed enough to reconstruct a portion of the graphical presentation that was previously presented on the EGM and the state of the EGM (e.g., credits) at the time the game of chance was played. The game history information may be utilized in the event of a dispute. For example, a player may decide that in a previous game of chance that they did not receive credit for an award that they believed they won. The game history information may be used to reconstruct the state of the EGM before, during, and/or after the disputed game to demonstrate whether the player was correct or not in the player's assertion.

Another feature of EGMs is that they often include unique interfaces, including serial interfaces, to connect to specific subsystems internal and external to the EGM. The serial devices may have electrical interface requirements that differ from the "standard" EIA serial interfaces provided by general purpose computing devices. These interfaces may include, for example, Fiber Optic Serial, optically coupled serial interfaces, current loop style serial interfaces, etc. In addition, to conserve serial interfaces internally in the EGM, serial devices may be connected in a shared, daisy-chain fashion in which multiple peripheral devices are connected to a single serial channel.

The serial interfaces may be used to transmit information using communication protocols that are unique to the gaming industry. For example, IGT's Netplex is a proprietary communication protocol used for serial communication between EGMs. As another example, SAS is a communication protocol used to transmit information, such as metering information, from an EGM to a remote device. Often SAS is used in conjunction with a player tracking system.

Certain EGMs may alternatively be treated as peripheral devices to a casino communication controller and connected in a shared daisy chain fashion to a single serial interface. In both cases, the peripheral devices are assigned device addresses. If so, the serial controller circuitry must implement a method to generate or detect unique device addresses. General purpose computing device serial ports are not able to do this.

Security monitoring circuits detect intrusion into an EGM by monitoring security switches attached to access doors in the EGM cabinet. Access violations result in suspension of game play and can trigger additional security operations to preserve the current state of game play. These circuits also function when power is off by use of a battery backup. In power-off operation, these circuits continue to monitor the access doors of the EGM. When power is restored, the EGM can determine whether any security violations occurred while power was off, e.g., via software for reading status registers. This can trigger event log entries and further data authentication operations by the EGM software.

Trusted memory devices and/or trusted memory sources are included in an EGM to ensure the authenticity of the software that may be stored on less secure memory subsystems, such as mass storage devices. Trusted memory devices and controlling circuitry are typically designed to not enable modification of the code and data stored in the memory device while the memory device is installed in the EGM. The code and data stored in these devices may include authentication algorithms, random number generators, authentication keys, operating system kernels, etc. The purpose of these trusted memory devices is to provide gaming regulatory authorities a root trusted authority within the computing environment of the EGM that can be tracked and verified as original. This may be accomplished via removal of the trusted memory device from the EGM computer and verification of the secure memory device contents is a separate third party verification device. Once the trusted memory device is verified as authentic, and based on the approval of the verification algorithms included in the trusted device, the EGM is enabled to verify the authenticity of additional code and data that may be located in the gaming computer assembly, such as code and data stored on hard disk drives.

In at least one embodiment, at least a portion of the trusted memory devices/sources may correspond to memory that cannot easily be altered (e.g., "unalterable memory") such as EPROMS, PROMS, Bios, Extended Bios, and/or other memory sources that are able to be configured, verified, and/or authenticated (e.g., for authenticity) in a secure and controlled manner.

According to one embodiment, when a trusted information source is in communication with a remote device via a network, the remote device may employ a verification scheme to verify the identity of the trusted information source. For example, the trusted information source and the remote device may exchange information using public and private encryption keys to verify each other's identities. In another embodiment, the remote device and the trusted information source may engage in methods using zero knowledge proofs to authenticate each of their respective identities.

EGMs storing trusted information may utilize apparatuses or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

Mass storage devices used in a general purpose computing devices typically enable code and data to be read from and written to the mass storage device. In a gaming environment, modification of the gaming code stored on a mass storage device is strictly controlled and would only be enabled under specific maintenance type events with electronic and physical enablers required. Though this level of security could be provided by software, EGMs that include mass storage devices include hardware level mass storage data protection circuitry that operates at the circuit level to monitor attempts to modify data on the mass storage device and will generate both software and hardware error triggers should a data modification be attempted without the proper electronic and physical enablers being present.

Various changes and modifications to the present embodiments described herein will be apparent to those skilled in the art. Such changes and modifications can be made without departing from the spirit and scope of the present subject matter and without diminishing its intended technical scope. It is therefore intended that such changes and modifications be covered by the appended claims.

What is claimed is:

1. An electronic gaming machine (EGM) comprising:
a display device;
an input device;
a game controller comprising a processor circuit;
a trusted memory device which stores a plurality of instructions, which when executed by the processor circuit, cause the processor circuit to:
control a graphical user interface (GUI) of the display device to automatically display, in response to receiving a wager from a user of the EGM via the input device, a wagering game comprising:
a plurality of reels each comprising a plurality of primary game symbols corresponding to a primary game on the EGM and configured to move in a first direction;
a plurality of prize disks each comprising a plurality of bonus game symbols corresponding to a secondary game on the EGM and configured to move in a second direction that is different from the first direction; and
an unlock symbol that comprises a first unlock symbol that corresponds to an unlock function of one of the plurality of prize disks or a second unlock symbol that corresponds to a lock function of one of the plurality of prize disks, wherein the unlock symbol comprises a displayed symbol for an unlock symbol and does not include the actual displayed symbol for a lock symbol;
in response to the unlock symbol comprising the first unlock symbol, control the GUI to unlock one of the plurality of prize disks to become unlocked;
in response to one of the plurality of primary game symbols comprising a secondary game symbol, control the GUI to provide the user access to the secondary game;
in response to one of the plurality of prize disks becoming unlocked and the one of the plurality of primary game symbols comprising the secondary game symbol, control the GUI to automatically award the user with a bonus game award comprising a combination of corresponding ones of the plurality of bonus game symbols,
wherein the graphical interface causes the one of the plurality of prize disks in a first unlock symbol to be displayed in a position that is based on the first unlock symbol;
a power supply; and
a voltage monitoring circuit that causes the processor circuit to:
generate an error indication in response to a power supply voltage of the power supply being out of a first tolerance range of the power supply and within a second tolerance range of the power supply; and
suspend operation of the wagering game in response to the power supply voltage being out of the second tolerance range of the power supply.

2. The EGM of claim 1,
wherein the first direction corresponding to the plurality of reels is up or down, and
wherein the second direction corresponding to the plurality of prize disks is horizontal to a left direction or horizontal to a right direction.

3. The EGM of claim 1,
wherein the plurality of prize disks comprises a first prize disk and a second prize disk,
wherein the first prize disk is between the plurality of reels and the second prize disk, and
wherein the first prize disk is configured to move in a first direction of left and right directions and the second prize disk is configured to move in a second direction of the left and right directions that is different from the first direction.

4. The EGM of claim 1, wherein corresponding ones of the plurality of bonus game symbols in the plurality of prize disks are in a same column as the secondary game symbol in one of the plurality of reels.

5. The EGM of claim 1, wherein responsive to the unlock symbol comprising the first unlock symbol, all of one of the plurality of prize disks is unlocked.

6. The EGM of claim 1, wherein responsive to the unlock symbol comprising the first unlock symbol, only a single column in one of the plurality of prize disks is unlocked.

7. The EGM of claim 1, wherein the plurality of prize disks comprises a first prize disk, a second prize disk and a third prize disk,
wherein the first prize disk comprises a first side that is adjacent the plurality of reels and a second side that is opposite the first side,
wherein the second prize disk comprises a third side that is adjacent the second side of the first prize disk and a fourth side that is opposite the third side of the second prize disk, and
wherein the third prize disk comprises a fifth side that is adjacent the fourth side of the second prize disk.

8. The EGM of claim 7, wherein a game starts with the first prize disk active,
wherein the second prize disk comprises the unlock symbol,
wherein the third prize disk is unlockable based on the unlock symbol of the second prize disk,
wherein the secondary game symbol triggers the bonus game award, and
wherein the third prize disk resets to locked at a beginning of a next play of the game.

9. The EGM of claim 7, wherein the unlock symbol comprises a plurality of unlock symbols that comprises a first unlock symbol and a second unlock symbol,
wherein, responsive to the first prize disk comprising the first unlock symbol, the second prize disk is unlocked, and
wherein, responsive to the second prize disk comprising the second unlock symbol, the third prize disk in unlocked.

10. The EGM of claim 1, wherein the plurality of prize disks comprises a first prize disk and a second prize disk, and
wherein, responsive to the first unlock symbol being on the first prize disk, the second prize disk is unlocked without unlocking the first prize disk.

11. The EGM of claim 1, wherein the plurality of prize disks comprises a first prize disk and a second prize disk,
wherein, in response to the second unlock symbol being on the first prize disk, the second prize disk is locked.

12. The EGM of claim 1, wherein the unlock symbol is persistent to be active for multiple plays of the primary game.

13. The EGM of claim 1, wherein the unlock symbol comprises a plurality of unlock symbols,
wherein ones of the plurality of unlock symbols are in cells of a top row in the plurality of reels with ones of the plurality of primary game symbols.

14. The EGM of claim 1, wherein, responsive to displaying the unlock symbol on a first game play, one of the plurality of prize disks is unlocked for a second game play that occurs after the first game play.

15. The EGM of claim 1, wherein the plurality of prize disks comprises a first prize disk and a second prize disk,
wherein the first prize disk comprises money values and second prize disk comprises a multiplier,
wherein the bonus game award comprises a product of the money value and multiplier in a column corresponding to the secondary game symbol.

16. The EGM of claim 1, wherein the plurality of prize disks comprises a first prize disk and a second prize disk,
wherein a game starts with the first prize disk active and comprising the unlock symbol,
wherein the second prize disk is unlockable based on unlock symbol value in first prize disk, and
wherein the secondary game symbol in one of the plurality of reels triggers the bonus game award, and
wherein the second prize disk resets to locked at a beginning of next game play.

17. The EGM of claim 1, wherein the plurality of prize disks comprises a first prize disk and a second prize disk,
wherein the first prize disk is unlocked and the second prize disk is locked,
wherein the first prize disk and the second prize disk are visible to the user.

18. A game controller for an electronic gaming machine (EGM) comprising:
a processor circuit; and
a trusted memory device which stores a plurality of instructions, which when executed by the processor circuit cause the processor circuit to:
control a graphical user interface (GUI) of a display device of the EGM to automatically display, in response to receiving a wager from a user of the EGM via an input device of the EGM, a wagering game comprising:
a plurality of reels each comprising a plurality of primary game symbols corresponding to a primary game on the EGM and configured to rotate about a first axis;
a plurality of prize disks each comprising a plurality of bonus game symbols corresponding to a secondary game on the EGM and configured to rotate about a second axis that is orthogonal to the first axis; and
an unlock symbol that corresponds to an unlock function of one of the plurality of prize disks, wherein the unlock symbol comprises a displayed symbol for an unlock symbol and does not include the actual displayed symbol for a lock symbol;
automatically determine that the unlock symbol corresponds to one of the plurality of prize disks;
automatically determine that one of the plurality of primary game symbols comprises a secondary game symbol that corresponds to user access to the secondary game; and
in response to one of the plurality of prize disks becoming unlocked and the one of the plurality of primary game symbols comprising the secondary game symbol, control the GUI to automatically award the user with a bonus game award,
wherein the graphical interface causes the one of the plurality of prize disks in a first unlock symbol to be displayed in a position that is based on the first unlock symbol.

19. The gaming system of claim 18, wherein the bonus game award comprises a product of a money value in a first prize disk of the plurality of prize disks and a multiplier in a second prize disk of the plurality of prize disks.

20. A method of operating a gaming system comprising:
controlling, via a game controller of an electronic gaming machine (EGM), a graphical user interface (GUI) of a display device of the EGM, in response to receiving, via a payment device of the EGM that receives value, a wager from a user of the EGM, display a wagering game comprising:
a plurality of reels each comprising a plurality of primary game symbols corresponding to a primary game on the EGM and configured to rotate about a first axis;
a plurality of prize disks each comprising a plurality of bonus game symbols corresponding to a secondary game on the EGM and configured to rotate about a second axis that is orthogonal to the first axis; and
an unlock symbol that corresponds to an unlock function of one of the plurality of prize disks, wherein the unlock symbol comprises a displayed symbol for an unlock symbol and does not include the actual displayed symbol for a lock symbol;
in response to the unlock symbol corresponding to one of the plurality of prize disks, controlling the GUI to unlock the prize disk;
in response to one of the plurality of primary game symbols comprising a secondary game symbol, controlling the GUI to provide the user access to the secondary game; and
in response to the one of the plurality of prize disks becoming unlocked and the one of the plurality of primary game symbols comprising the secondary game symbol, controlling the GUI to automatically award the user with a bonus game award,
wherein the plurality of prize disks comprises a first prize disk and a second prize disk,
wherein the first prize disk is between the plurality of reels and the second prize disk, and
wherein the first prize disk is configured to move in a first direction of left and right directions and the second prize disk is configured to move in a second direction of the left and right directions that is different from the first direction,
wherein the graphical interface causes the one of the plurality of prize disks in a first unlock symbol to be displayed in a position that is based on the first unlock symbol.
